(19) United States
(12) Patent Application Publication
(10) Pub. No.: US 2026/0343494 A1
(43) Pub. Date: Oct. 29, 2026

(54) METHODS, APPARATUSES, DEVICES, AND SYSTEMS FOR COMMUNICATIONS DURING AN INACTIVE STATE

(71) Applicant: Huawei Technologies Co., Ltd., Shenzhen (CN)

(72) Inventors: Ahmad Mustafa Musa Abu Al Haija, Ottawa (CA); Mohammadhadi Baligh, Ottawa (CA)

(21) Appl. No.: 19/730,179

(22) Filed: Jul. 2, 2026

Related U.S. Application Data
(63) Continuation of application No. PCT/CN2024/070721, filed on Jan. 5, 2024.

(51) Int. Cl. H04W 72/04

(52) U.S. Cl. CPC H04W 72/04

(57) ABSTRACT

Aspects of the present disclosure provide methods, apparatuses, devices, and systems for communications during an inactive state. An apparatus may receive information pertaining to configured grant (CG) configurations indicating resources that are available to be used by the apparatus for the communication with the network device. The apparatus may determine, based on the information pertaining to CG configurations, a CG configuration to be used by the apparatus for transmission of a signal during an inactive state. The determined CG configuration may be associated with events within an area in which the apparatus and the network device are located. The apparatus may transmit the signal over a CG resource indicated in the determined CG configuration during the inactive state.

### CROSS REFERENCE

This application is a continuation of International Application No. PCT/CN2024/070721, filed on Jan. 5, 2024. The disclosure of the aforementioned application is hereby incorporated by reference in its entirety.

### TECHNICAL FIELD

The present disclosure relates generally to wireless communications, and in particular to methods, apparatuses, devices, and systems for determining a configured grant (CG) configuration for an inactive state communication in a wireless network.

### BACKGROUND

In wireless communication systems such as Fifth Generation (5G) New Radio (NR), in addition to existing RRC connection states, namely RRC_CONNECTED and RRC_IDLE, a new state that is referred to as RRC_INACTIVE has been introduced to address challenges in Fourth Generation (4G) long-term evolution (LTE) networks. For example, RRC_INACTIVE has been employed to save power of apparatuses (e.g., user device, user equipment (UE)), reduce overhead signaling (e.g., for transitioning between idle and connected states), and/or minimize latency for small data transmission (SDT).

SDT is a procedure used for data and/or signalling transmission when an apparatus (e.g., UE) stays in an inactive state (e.g., RRC_INACTIVE), without transitioning to a connected state (RRC_CONNECTED). The SDT may be performed such that an apparatus (e.g., UE) in an inactive state (e.g., RRC_INACTIVE) sends small data (e.g., data less than a certain amount) over allowed radio bearers. The SDT may be performed using random access based SDT (RA-SDT), or using preconfigured radio resources, which is known as configured grant based SDT (CG-SDT). In a case where the SDT is performed using the RA-SDT, the radio resources may be provided to the UE via system information messages. In a case where the SDT is performed using the CG-SDT, the CG resources and scheduling may be provided to the UE before transitioning from a connected state (RRC_CONNECTED) to an inactive state (RRC_INACTIVE). For RA-SDT and CG-SDT, the resources may be configured on either or both of normal UL (NUL) and supplementary UL (SUL) carriers.

In wireless communication networks where new nodes (e.g., reconfigurable intelligent surfaces (RISs)) may be employed, such as Sixth Generation (6G) networks, the SDT procedure may be affected due to operations of the new nodes.

Therefore, there is a need for new methods, apparatuses, devices, and systems for communications between apparatuses and devices in wireless communication networks (e.g., 6G), particularly in relation to transmissions from apparatuses in an inactive state to devices on the network side.

### SUMMARY

As noted above, in existing wireless communication systems (e.g., 5G NR), small data transmission (SDT) may be performed via preconfigured radio resources. Such SDT is known as configured grant based SDT (CG-SDT). In the standard adopted for 5G NR, multiple configured grant (CG) configurations are allowed for the CG-SDT so that one or multiple synchronization signal blocks (SSBs) may be associated with more than one CG configuration. However, with introduction of new nodes in the network, the SDT and CG configurations may need to take into consideration operations of the new nodes (e.g., behaviours of RISs). For example, in a network in which a reconfigurable intelligent surface (RIS) is employed, resources (e.g., CG resources) that allow an SSB to be received by an apparatus when the SSB is redirected by the RIS may be different from (or a subset of) the resources that allow the same SSB to be received by the apparatus when the SSB is not redirected by the RIS. A RIS is a device that has multiple individually configurable reflective elements to redirect a signal that impinges upon the surface and may be positioned between a base station and a user equipment (UE) or between multiple UEs. This may occur because, for example, the bandwidth over which the RIS operates may be narrower than the total available bandwidth for communication (therefore, CG resources that are not within the bandwidth over which RIS operates may not be used for SDT with RIS support), or the frequency of the signal is changed after being redirected by the RIS. Therefore, the properties and/or operation of an RIS may need to be considered when an apparatus served by the RIS attempts to transmit data to a device on the network side (e.g., base station (BS)) while the apparatus remains in an inactive state. In the present disclosure, an apparatus may be considered to be served by the RIS when an apparatus is capable of receiving a signal redirected by the RIS. In the present disclosure, an RIS may be considered to serve an apparatus or a network device when the RIS acts to redirect a signal to the apparatus or the network device. In the present disclosure, an apparatus may be considered to be covered by an RIS when an apparatus is within a coverage area of the RIS so that the apparatus may be served by the RIS. In the present disclosure, an area covered by the RIS may be considered an area within which the RIS is able to redirect a signal to the apparatus, and may be referred to as a coverage area of the RIS.

Aspects of the present disclosure provide solutions to overcome the potential issues described above, as well as specific methods, apparatuses, network devices, and systems for communications between apparatuses and network devices in a wireless network during an inactive state.

According to an aspect of the disclosure there is provided a method for use by an apparatus for communication with a network device including: receiving information pertaining to configured grant (CG) configurations indicating one or more resources that are available to be used by the apparatus for the communication with the network device; determining, based on the information pertaining to CG configurations, a CG configuration to be used by the apparatus for transmission of a signal during an inactive state, the determined CG configuration associated with one or more events within an area in which the apparatus and the network device are located; and transmitting the signal over a CG resource indicated in the determined CG configuration during the inactive state.

In some embodiments, the one or more events are associated with at least one of a reconfigurable intelligent surface (RIS) within the area or a location of the apparatus within the area.

In some embodiments, the determined CG configuration comprises a time and frequency resource associated with the one or more events.

In some embodiments, the information pertaining to CG configurations is included in a radio resource control (RRC) message that triggers the apparatus to transition from an RRC_CONNECTED state to an RRC_INACTIVE state.

In some embodiments, wherein the area refers to at least one of: a cell area in which the apparatus receives the RRC message that triggers the apparatus to transition from the RRC_CONNECTED state to the RRC_INACTIVE state; or a radio access network (RAN) based notification area (RNA).

In some embodiments, the information pertaining to CG configurations includes at least one of: one or more CG configurations for the communication with the network device; one or more CG configurations associated with the one or more events; or information indicative of how to detect the RIS.

In some embodiments, the one or more CG configurations associated with the one or more events include at least one of: information indicative of a frequency band associated with the RIS; or information indicative of one or more areas in which the apparatus is served by the RIS.

In some embodiments, the information indicative of how to detect the RIS specifies detecting the RIS based on at least one of: one or more RIS broadcast signals transmitted from the RIS; information indicative of an area covered by the RIS; or an indication of the RIS included in a paging signal and/or SSB signal transmitted from the network device, the indication of the RIS overlaid onto the paging signal and/or SSB signal via a media based modulation (MBM).

In some embodiments, the determining the CG configuration includes at least one of: detecting the RIS using the information indicative of how to detect the RIS included in the information pertaining to CG configurations; determining proximity between the RIS and the apparatus; or selecting a time frequency resource associated with the RIS based on the proximity between the RIS and the apparatus, the selected time frequency resource being indicated as the CG resource in the CG configuration.

In some embodiments, the information pertaining to CG configurations includes at least one of: one or more CG configurations for the communication with the network device; one or more indications for one or more CG configurations that are available for use by the apparatus to transmit the signal; or information indicative of one or more particular CG resource sets for use by the apparatus to transmit the signal.

In some embodiments, the determining the CG configuration includes: selecting a time frequency resource associated with the RIS and available for the transmission of the signal based on at least one of the one or more CG configurations for the communication with the network device, or the one or more indications for one or more CG configurations that are available for use by the apparatus to transmit the signal, the selected time frequency resource being indicated as the CG resource in the CG configuration; or selecting a time frequency resource associated with the RIS based on the information indicative of the one or more particular CG resource sets for use by the apparatus to transmit the signal, the selected time frequency resource being indicated as the CG resource in the CG configuration.

In some embodiments, the method may further include: receiving a signaling configuring the apparatus to transmit a sounding reference signal (SRS); and transmitting the SRS.

In some embodiments, the information pertaining to CG configurations includes the information indicative of the one or more particular CG resource sets for use by the apparatus to transmit the signal, the apparatus receives the information pertaining to CG configurations after the location of the apparatus is determined to be within an area covered by the RIS.

In some embodiments, the RIS is configured by the network device to redirect the signal transmitted by the apparatus to the network device based on the determined CG configuration.

In some embodiments, the signal transmitted by the apparatus is redirected to the network device via the RIS.

In some embodiments, the method may further include: after transmitting the signal, transmitting one or more subsequent signals.

In some embodiments, transmitting the one or more subsequent signals include: determining a time frequency resource based on the determined CG configuration; and transmitting a subsequent signal over the determined time frequency resource during the inactive state.

In some embodiments, the method may further include transmitting a request for transmission of the one or more subsequent signals including at least one of a buffer status report or information that facilitates the transmission of the one or more subsequent signals.

In some embodiments, the method may further include receiving information indicative of at least one of: a maximum number of the one or more subsequent transmissions; or a direction in which the apparatus is to transmit the one or more subsequent signals during a time period that the RIS is not configured to redirect the one or more subsequent signals to the network device.

In some embodiments, the method may further include monitoring a downlink control channel during transmission of the one or more subsequent signals.

In some embodiments, the apparatus monitors the downlink control channel during discontinuous reception (DRX).

In some embodiments, the apparatus monitors the downlink control channel during a time period that the RIS is configured to redirect the one or more subsequent signals to the network device.

In some embodiments, the signal comprises a connection resume request message and payload data.

In some embodiments, the method may further include transmitting a request for one or more CG configurations to be used by the apparatus for the transmission of the signal during the inactive state.

In some embodiments, wherein the signal conveys data having a size that is equal to or less than a particular data size.

According to an aspect of the disclosure there is provided an apparatus comprising means to perform any of the methods mentioned in this disclosure. In details, the apparatus including a processor coupled with a computer-readable medium. The computer-readable medium is configured to store computer-executable instructions and the processor is configured to execute the computer-executable instructions to cause the apparatus to perform a method consistent with the embodiments described above and herein. A non-limiting example of the apparatus is a user equipment (UE). In some embodiments, the apparatus comprises a chip, e.g., an integrated circuit (IC) chip. In some embodiments, the apparatus does not execute instructions by a processor to perform the methods, e.g., the apparatus may comprise circuitry such as a field-programmable gate array (FPGA), a graphical processing unit (GPU), or an application-specific integrated circuit (ASIC), that performs the methods. More generally, the apparatus may comprise modules or units or means to perform the methods.

According to an aspect of the disclosure there is provided a method applied in a device for communication with an apparatus including: transmitting information pertaining to configured grant (CG) configurations indicating one or more resources that are available to be used by the apparatus for communication with the device, wherein the information pertaining to CG configurations is used for determining a CG configuration that is associated with one or more events within an area in which the apparatus and the device are located; and receiving the signal transmitted from the apparatus over a CG resource associated with the CG configuration determined using the information pertaining to CG configurations during the inactive state.

In some embodiments, the one or more events are associated with at least one of a reconfigurable intelligent surface (RIS) within the area or a location of the apparatus within the area.

In some embodiments, the determined CG configuration comprises a time and frequency resource associated with the one or more events.

In some embodiments, the information pertaining to CG configurations is transmitted in a radio resource control (RRC) message that triggers the apparatus to transition from an RRC_CONNECTED state to an RRC_INACTIVE state.

In some embodiments, wherein the area refers to at least one of: a cell area in which the apparatus receives the RRC message that triggers the apparatus to transition from the RRC_CONNECTED state to the RRC_INACTIVE state; or a radio access network (RAN) based notification area (RNA).

In some embodiments, the information pertaining to CG configurations includes at least one of: one or more CG configurations for the communication with the device; one or more CG configurations associated with the one or more events; or information indicative of how to detect the RIS.

In some embodiments, the one or more CG configurations associated with the one or more events include at least one of: information indicative of a frequency band associated with the RIS; or information indicative of one or more areas in which the apparatus is served by the RIS.

In some embodiments, the information indicative of how to detect the RIS specifies detecting the RIS based on at least one of: one or more RIS broadcast signals transmitted from the RIS; information indicative of an area covered by the RIS; or an indication of the RIS included in a paging signal and/or SSB signal transmitted from the device, the indication of the RIS overlaid onto the paging signal and/or SSB signal via a media based modulation (MBM).

In some embodiments, the information pertaining to CG configurations includes at least one of: one or more CG configurations for the communication with the device; one or more indications for one or more CG configurations that are available for use by the apparatus to transmit the signal; or information indicative of one or more particular CG resource sets for use by the apparatus to transmit the signal.

In some embodiments, the method may further include: transmitting a signaling configuring the apparatus to transmit a sounding reference signal (SRS); receiving the SRS; and determining the location of the apparatus based on the received SRS.

In some embodiments, when the information pertaining to CG configurations includes the information indicative of the one or more particular CG resource sets for use by the apparatus to transmit the signal, the device transmits the information pertaining to CG configurations after determining that the location of the apparatus is within an area covered by the RIS.

In some embodiments, the CG resource is determined based on the information indicative of the one or more particular CG resource sets for use by the apparatus to transmit the signal.

In some embodiments, the method may further include transmitting a signal configuring the RIS to redirect the signal transmitted by the apparatus to the device based on the determined CG configuration.

In some embodiments, the signal transmitted by the apparatus is redirected to the device via the RIS.

In some embodiments, the method may further include after receiving the signal, receiving one or more subsequent signals.

In some embodiments, receiving the one or more subsequent signals include receiving a subsequent signal over a time frequency resource selected based on the determined CG configuration during the inactive state.

In some embodiments, the method may further include receiving a request for transmission of the one or more subsequent signals including at least one of a buffer status report or information that facilitates the transmission of the one or more subsequent signals.

In some embodiments, the method may further include transmitting information indicative of at least one of: a maximum number of the one or more subsequent transmissions; or a direction in which the apparatus is to transmit the one or more subsequent signals during a time period that the RIS is not configured to redirect the one or more subsequent signals to the device.

In some embodiments, the method may further include during transmission of the one or more subsequent signals, transmitting a downlink control channel that carries at least one of dynamic grants or feedback to the apparatus.

In some embodiments, the device transmits the downlink control channel during discontinuous reception (DRX).

In some embodiments, the device transmits the downlink control channel during a time period that the RIS is configured to redirect the one or more subsequent signals to the apparatus.

In some embodiments, the signal comprises a connection resume request message and payload data.

In some embodiments, the method may further include receiving a request for one or more CG configurations to be used by the apparatus for transmission of the signal during the inactive state.

In some embodiments, wherein the signal conveys data having a size that is equal to or less than a particular data size.

According to an aspect of the disclosure there is provided a device comprising means to perform any of the methods mentioned in this disclosure. In details, the device includes a processor coupled with a computer-readable medium. The computer-readable medium stores thereon computer-executable instructions that when executed cause the device to perform a method consistent with the embodiments described above and herein. A non-limiting example of the apparatus is a base station (BS). In some embodiments, the device comprises a chip, e.g., an IC chip. In some embodiments, the device does not execute instructions by a processor to perform the methods, e.g., the device may comprise circuitry such as an FPGA, a GPU, or an ASIC, that performs the methods. More generally, the device may comprise modules or units or means to perform the methods.

According to an aspect of the disclosure, there is provided a computer-readable storage medium. The computer-readable storage medium stores computer-executable instructions that, when executed, cause a computer to perform a method as described above or elsewhere in the present disclosure. The computer-readable storage medium may be non-transitory.

According to an aspect of the disclosure, there is provided a computer-program. The computer program comprises computer-executable instructions that, when executed, cause a computer to perform a method as described above or elsewhere in the present disclosure.

In some aspects of the present disclosure, there is provided an apparatus/chipset system comprising means (e.g., at least one processor) to implement the method implemented by (or at) a UE of the present disclosure. The apparatus/chipset system may be the UE (that is, a terminal device) or a module/component in the UE. In details, the at least one processor may execute instructions stored in a computer-readable medium to implement the method.

In some aspects of the present disclosure, there is provided an apparatus/chipset system comprising means (e.g., at least one processor) to implement the method implemented by (or at) a network device (e.g., base station) of the present disclosure. The apparatus/chipset system may be the network device or a module/component in the network device. In details, the at least one processor may execute instructions stored in a computer-readable medium to implement the method.

In some aspects of the present disclosure, there is provided a system comprising at least one of an apparatus in (or at) a UE of the present disclosure, or an apparatus in (or at) a network device of the present disclosure.

In some aspects of the present disclosure, there is provided a method performed by a system comprising at least one of an apparatus in (or at) a UE of the present disclosure, or an apparatus in (or at) a network device of the present disclosure.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 is a schematic diagram of a communication system in which embodiments of the present disclosure may occur.

FIG. 2 is another schematic diagram of a communication system in which embodiments of the present disclosure may occur.

FIG. 3A is a block diagram illustrating units or modules in a device in which embodiments of the present disclosure may occur.

FIG. 3B is a block diagram of an example reconfigurable intelligent surfaces (RIS).

FIG. 4 is a block diagram illustrating units or modules in a device in which embodiments of the present disclosure may occur.

FIG. 5 illustrates an example of a portion of a wireless communication network that includes multiple reconfigurable intelligent surfaces (RISs) that operate at different bandwidths, in accordance with embodiments of the present disclosure.

FIG. 6 illustrates an example of a portion of a wireless communication network that includes an RIS that redirects signals to multiple network devices over different time resources, in accordance with embodiments of the present disclosure.

FIG. 7 illustrates an example configured grant (CG) configuration for time frequency resources for a communication between an apparatus and a network device in a wireless communication network.

FIG. 8 is a signal flow diagram illustrating an example method for communication between an apparatus and a network device where the apparatus is in an inactive state and is located within an area capable of receiving a signal redirected by an RIS that operates within a certain bandwidth, in accordance with embodiments of the present disclosure.

FIG. 9 is a signal flow diagram illustrating another example method for communication between an apparatus and a network device where the apparatus in an inactive state is located within an area capable of receiving a signal redirected by an RIS that operates within a certain bandwidth, in accordance with embodiments of the present disclosure.

FIG. 10 is a signal flow diagram illustrating an example method for communication between an apparatus and a network device where the apparatus in an inactive state is located within an area capable of receiving a signal redirected by an RIS that redirects signals to multiple network devices over different time resources, in accordance with embodiments of the present disclosure.

FIG. 11 illustrates an example of how an apparatus may transmit a signal to a network device in a network where an RIS redirects signals to multiple network devices over different time resources, in accordance with embodiments of the present disclosure.

FIG. 12 illustrates an example of how an apparatus may adapt discontinuous reception (DRX) and monitor a physical downlink control channel (PDCCH) during the adapted DRX, in accordance with embodiments of the present disclosure.

FIG. 13 is a signal flow diagram illustrating an example method for communication between an apparatus and a network device, involving an RIS, in accordance with embodiments of the present disclosure.

FIG. 14 illustrates an example method for communication between an apparatus and a network device during an inactive state, in accordance with embodiments of the present disclosure.

FIG. 15 illustrates an example of transitioning between different radio resource control (RRC) states for an apparatus.

### DETAILED DESCRIPTION OF THE ILLUSTRATIVE EMBODIMENTS

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

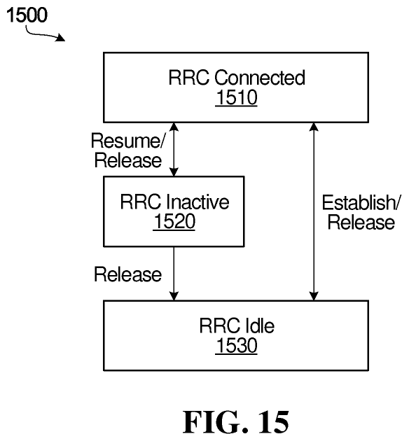

In the present disclosure, “RRC_INACTIVE” or “RRC_INACTIVE state” refers to an additional radio resource control (RRC) state for an apparatus, such as a user equipment (UE), introduced in wireless communication systems (e.g., Fifth Generation (5G) New Radio (NR)) in addition to “RRC_CONNECTED” and “RRC_IDLE”. When there is no traffic, the apparatus may stay in RRC_INACTIVE state without completely releasing an established RRC connection with the network. In RRC_INACTIVE state, the UE context is kept at UE and the last serving BS (before UE transition from RRC_CONNECTED to RRC_INACTIVE state). Moreover, the last serving BS keeps the UE-associated connection with core network (e.g. next generation (NG) connection with AMF (Access and Mobility Management Function) and UPF (User Plane Function)). Hence, whenever needed, the apparatus may quickly transition from “RRC_INACTIVE” state to “RRC_CONNECTED” state. Transitioning between “RRC_INACTIVE”, “RRC_CONNECTED” and “RRC_IDLE” is illustrated in FIG. 15.

FIG. 15 illustrates an example of transitioning 1500 between different radio resource control (RRC) states for an apparatus. An apparatus (not shown in FIG. 15), such as a UE, may be initially in the RRC_IDLE state 1530, for example when the apparatus is turned on. The apparatus may establish a connection with a network device (not shown in FIG. 15), such as a base station, in order to perform, for example, a data transmission. The initial connection between the apparatus and the network device may be established using initial access.

Once the connection between the apparatus and the network device is established, the apparatus may be in the RRC_CONNECTED state 1510. When in the RRC_CONNECTED states, all of the parameters that may be needed for communication between the apparatus and the network device may be known to both of the apparatus and the network device.

When there is no traffic (or low data activity (transmission/reception) over a certain duration of time), the apparatus may transition from the RRC Connected state 1510 to the RRC_INACTIVE state 1520. By transitioning to the RRC_INACTIVE state 1520, the apparatus do not need to completely release the RRC connection established with the network device. The apparatus may transition to the RRC_INACTIVE state 1520 via a RRC connection release message. For example, the apparatus may enter into the RRC_INACTIVE state 1520 when the apparatus receives an RRCRelease message with suspendConfig parameters. When the apparatus is in the RRC_INACTIVE state 1520, RRC connection may be considered suspended.

The apparatus, when needed, may quickly transition from RRC_INACTIVE state 1520 to RRC_CONNECTED state 1510, for example by transmitting an RRC resume request message (e.g., RRCResumeRequest message or RRCResumeRequest1 message) to the network device.

When there is no activity of the apparatus, the apparatus may transition to the RRC_IDLE state 1530 from either the RRC_CONNECTED state 1510 or the RRC_INACTIVE state 1520. The apparatus may transition to the RRC_IDLE state 1530 using an RRC connection release message. Upon transitioning from the RRC_CONNECTED state 1510 or the RRC_INACTIVE state 1520 to the RRC_IDLE state 1530, there may be no data transmission from or to the apparatus. The apparatus may sleep most of the time for example to reduce battery consumption. While the apparatus is in the RRC_IDLE state 1530, the network device may reach the apparatus through paging messages. When the apparatus needs to perform some activity (e.g., data transmission), the apparatus may transition from the RRC_IDLE state 1530 to the RRC_CONNECTED state 1510 by establishing a connection with the network device.

In the present disclosure, “small data transmission (SDT)” refers to a type or signaling, or more generally, a method for data transmission over allowed radio bearers in an inactive state (e.g., RRC_INACTIVE state). The SDT may not require an apparatus (e.g., UE) to transition to the connected mode (RRC_CONNECTED state).

In the present disclosure, “radio access network (RAN) based notification area (RNA)” refers to an area that consists of a cell or a group of cells in a wireless communications network (e.g., 5G network, 6G network or next generation network). When an apparatus moves within a certain RNA, paging messages may be exchanged to ensure that connectivity of the apparatus remains uninterrupted. The paging messages may be transmitted to every cell within the defined RNA. However, whenever a particular apparatus moves out of the RNA, the apparatus may need to report its location to the network side device (e.g., BS) operating within the RNA.

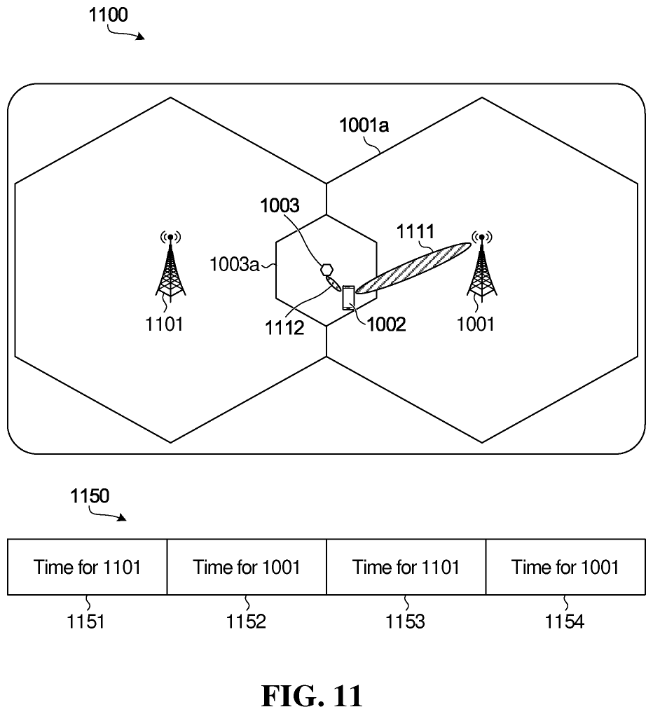

As noted above, with introduction of new nodes in the network (e.g., reconfigurable intelligent surfaces (RISs)), small data transmission (SDT) may need to be performed in consideration of the operations of the new nodes (e.g., behaviours of RISs), because, for example, transmission resources that allow a synchronization signal block (SSB) to be received by an apparatus when the SSB is redirected by the RIS may be different than the transmission resources that allow the same SSB to be received by the apparatus when the SSB is not redirected by the RIS. An example of such a scenario is described below with reference to FIG. 11.

Metasurfaces have been investigated in optical systems for some time and recently have attracted interest in wireless communication systems. These metasurfaces are capable of affecting a wavefront that impinges upon them. Some types of these metasurfaces are controllable, meaning through changing the electromagnetic properties of the surface, the properties of the surface can be changed. For example, manipulation of the amplitude and/or phase can be achieved by changing an impedance or relative permittivity (and/or permeability) of the metamaterial. An example of a metasurface is a reconfigurable intelligent surface (RIS).

Controllable metasurfaces are referred to by different names such as reconfigurable intelligent surface (RIS), large intelligent surface (LIS), intelligent reflecting surface (IRS), digital controlled surface (DCS), intelligent passive mirrors, and artificial radio space. While in subsequent portions of this document RIS is used most frequently when referring to these metasurfaces, it is to be understood then this is for simplicity and is not indented to limit the disclosure.

A RIS can realize “smart radio environment” or “smart radio channel” i.e. the environment radio propagation properties can be controlled to realize personalized channel for desired communication. The RIS may be established among multiple base stations to produce large scale smart radio channels that serve multiple users. With a controllable environment, RISs may first sense environment information and then feeds the environment information that has been sensed back to the system. According to this information, the system may optimize transmission mode parameters and RIS parameters through smart radio channels, at one or more of the transmitting apparatus or device (whether the base station or a UE), the channel and the receiving apparatus or device (whether the UE or a base station).

Because of beamforming gains associated with RISs, exploiting smart radio channels may significantly improve one or more of link quality, system performance, cell coverage, and cell edge performance in wireless networks. Not all RIS panels use the same structure. Different RIS panels may be designed with different types of phase adjusting capabilities that range from continuous phase control, to discrete control with multiple levels.

Another application of RISs is in transmitting apparatuses or devices that directly modulate incident radio one or more wave properties, such as phase, amplitude polarization and/or frequency without a need for active components as used in RF chains in traditional multiple input multiple output (MIMO) transmitting apparatuses or devices. RIS based transmitting apparatuses or devices have many merits, such as simple hardware architecture, low hardware complexity, low energy consumption and high spectral efficiency. Therefore, RISs provide a new direction for extremely simple transmitting apparatus or device design in future radio systems.

RIS assisted MIMO also may be used to assist fast beamforming with the use of accurate positioning, or to conquer blockage effects through CSI acquisition in mmWave systems. Alternatively, RIS assisted MIMO may be used in non-orthogonal multiple access (NOMA) in order to improve reliability at very low signal to noise ratio (SNR), accommodate more users and enable higher modulation schemes. RIS is also applicable to native physical security transmission, wireless power transfer or simultaneous data and wireless power transfer, and flexible holographic radios.

The ability to control the environment and network topology through strategic deployment of RISs, and other non-terrestrial (NT) and controllable nodes is an important paradigm shift in MIMO system, such as 6G MIMO. Such controllability is in contrast to the traditional communication paradigm, where transmitting apparatuses or devices and receiving apparatuses or devices adapt their communication methods to achieve the capacity predicted by information theory for the given wireless channel. Instead, by controlling the environment and network topology, MIMO aims to be able to change the wireless channel and adapt the network condition to increase the network capacity.

One way to control the environment is to adapt the topology of the network as user distribution and traffic patterns change over time. This involves utilizing high altitude pseudo satellites (HAPs), unmanned ariel vehicles (UAVs) and drones when and where it is necessary.

RIS-assisted MIMO utilizes RISs to enhance the MIMO performance by creating a smart radio channels. To extract full potential of RIS-assisted MIMO, a system architecture and more efficient scheme are provided in the present disclosure.

A RIS may include many small configurable elements, often comparable in size with the wavelength (for example, from 1/10 to a couple of wavelengths). Each element can be controlled independently. The control mechanism may be, for example, a bias voltage or a driving current to change the characteristics of the element. The combination of the control voltages for all elements (and hence the effective response) may be referred to as the RIS pattern. This RIS pattern may control the behavior of the RIS including at least one of the width, shape and direction of the beam, which is referred to as the beam pattern.

The controlling mechanism of the RIS often is through controlling the phase of a wavefront incident on the surface and reflected by the surface. Other techniques of controlling the RIS include attenuating reflection of the amplitude to reduce the reflected power and “switching off” the surface. Attenuating the power and switching off the surface can be realized by using only a portion of the RIS, or none of the RIS, for reflection while applying a random pattern to the rest of the panel, or a pattern that reflects the incident wavefront in a direction that is not in a desired direction.

In some portions of this disclosure, RIS may be referred to as a set of configurable elements arranged in a linear array or a planar array. Nevertheless, the analysis and discussions are extendable to two or three dimensional arrangements (e.g., circular array). A linear array is a vector of N configurable elements and a planar array is a matrix of N×M configurable elements, where N and M are non-zero integers. These configurable elements have the ability to redirect a wave/signal that is incident on the linear or planar array by changing the phase of the wave/signal. The configurable elements are also capable of changing the amplitude, polarization, or even the frequency of the wave/signal. In some planar arrays these changes occur as a result of changing bias voltages that control the individual configurable elements of the array via a control circuit connected to the linear or planar array. The control circuit that enables control of the linear or planar array may be connected to a communications network that base stations and UEs communicating with each other are part of. For example, the network that controls the base station may also provide configuration information to the linear or planar array. Control methods other than bias voltage control include, but are not limited to, mechanical deformation and phase change materials.

Aspects of the present disclosure provide solutions to overcome the potential issues described above, as well as specific methods, apparatuses, network devices, and systems for communications between apparatuses and network devices in a wireless network during an inactive state. In an aspect of the present disclosure, an apparatus (e.g., UE) and a network device (e.g., BS) may communicate during an inactive state (e.g., RRC_INACTIVE) and perform one or multiple SDTs using a CG configuration associated with one or more events. In an aspect of the present disclosure, the apparatus may adapt discontinuous reception (DRX) and timing for monitoring a downlink control channel to receive dynamic grants (may refer to other resources the apparatus may use for transmitting one or more SDTs) and/or feedback from the network device during multiple SDTs. In an aspect of the present disclosure, an apparatus may perform the SDT (e.g., transmitting small data to a network device) using one beam while the RIS redirects signals to the network device to which the apparatus attempts to send the data, and using another beam (i.e., different beam) while the RIS redirects signals to another network device that is different from the network device to which the apparatus attempts to send the data.

By virtue of some aspects of the present disclosure, the CG-SDT may be performed in accordance with operation of an RIS employed in a network so that appropriate time frequency resources may be used, which enable a signal from the apparatus to be received by the network device after being redirected by the RIS. It should be noted that in the present disclosure, “time frequency resource” or any similar term may refer to time resource, frequency resource, and/or time and frequency resource. By virtue of some aspects of the present disclosure, power consumption of an apparatus during an inactive state may be reduced. By virtue of some aspects of the present disclosure, CG-SDT may be performed in accordance with operation of an RIS employed in a network so that data may be transmitted, in a consecutive manner, from the apparatus to the network device during the inactive state.

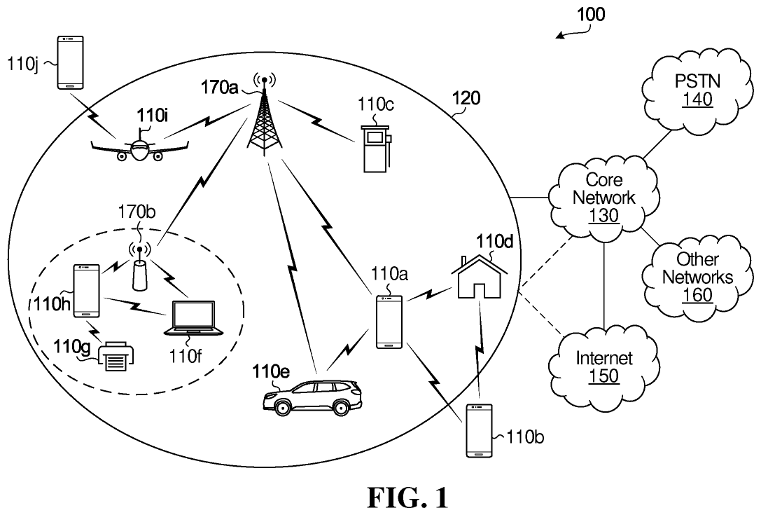

FIGS. 1, 2, and 3 following below provide context for the network and device that may be in the network and that may implement aspects of the present disclosure.

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

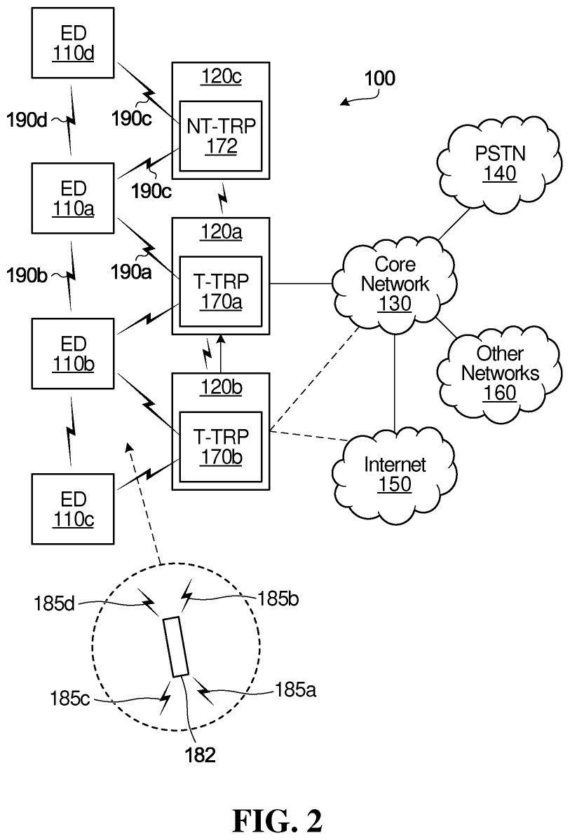

FIG. 2 illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 2, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 2 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 2, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 2, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 2, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell”, “coverage area”, or “cell area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110d over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b,172 may implement Universal Mobile Telecommunication System (UMTS) Terrestrial Radio Access (UTRA) to establish an air interface 190a, 190c using wideband CDMA (WCDMA). In doing so, the base station 170a-170b.172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b,172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1X, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 190b, 190d may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

Also shown in FIG. 2 is an RIS 182 located within the serving area of base station 170b. A first signal 185a is shown between the base station 170b and the RIS 182 and a second signal 185b is shown between the RIS 182 and the ED 110b, illustrating how the RIS 182 might be located within the uplink or downlink channel between the base station 170b and the ED 110b. Also shown is a third signal 185c between the ED 110c and the RIS 182 and a fourth signal 185d is shown between the RIS 182 and the ED 110b, illustrating how the RIS 182 might be located within the SL channel between the ED 110c and the ED 110b.

While only one RIS 182 is shown in FIG. 2, it is to be understood that any number of RIS could be included in a network.

In some embodiments, the signal is transmitted from a terrestrial BS to the UE or transmitted from the UE directly to the terrestrial BS and in both cases the signal is not reflected by an RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RISs are utilized to reflect the signal from a transmitting apparatus or transmitting device and a receiving apparatus or receiving device, where any of the transmitting apparatus, transmitting device, receiving apparatus and receiving device includes UEs, terrestrial or non-terrestrial BS, and relays.

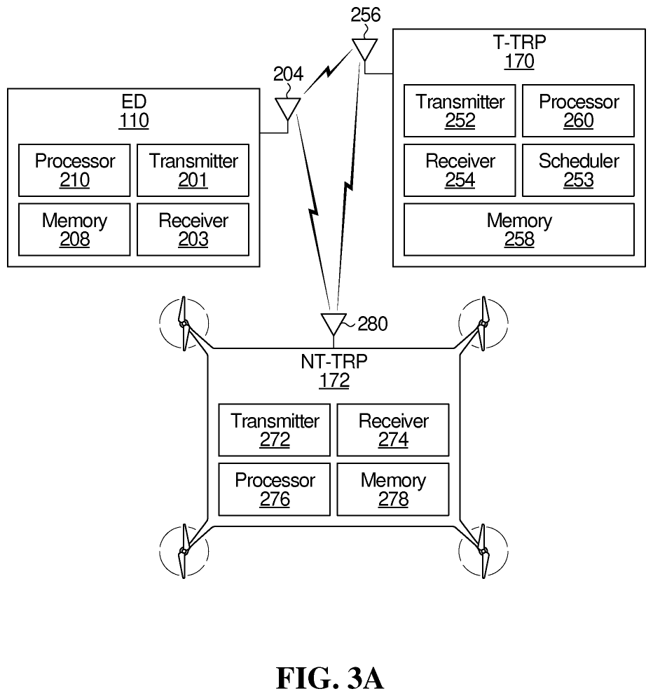

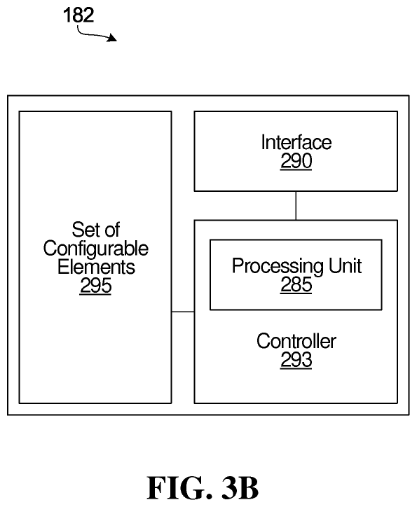

FIG. 3A illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the foregoing devices, among other possibilities. Future generation EDs 110 may be referred to using other terms. The base station 170a and 170b is a T-TRP and will hereafter be referred to as T-TRP 170. Also shown in FIG. 3A, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1 or 2). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the foregoing devices, or to apparatus (e.g. communication module, modem, or chip) in the foregoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 3A. FIG. 3A illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

While not shown in FIG. 3A, an RIS may be located between the ED 110 and the NT-TRP 172 or between the ED 110 and the T-TRP 170, in a similar manner as the RIS 182 is shown between the EDs 110 and base station 170b in FIG. 2. An RIS may be located between the NT-TRP 172 and the T-TRP 170 to aid in communication between the two TRPs.

Additional details regarding the EDs 110, T-TRP 170, and NT-TRP 172 are known to those of skill in the art. As such, these details are omitted here.

FIG. 3B illustrates an example RIS device that may implement the methods and teachings according to this disclosure. In particular, FIG. 3B illustrates an example RIS device 182. These components could be used in the system 100 shown in FIGS. 1 and 2, the system shown in FIG. 3A, or in any other suitable system.

As shown in FIG. 3B, the RIS device 182, which may also be referred to as a RIS panel, includes a controller 293 that includes at least one processing unit 285, an interface 290, and a set of configurable elements 295. The set of configurable elements are arranged in a single row or a grid or more than one row, which collectively form the reflective surface of the RIS panel. The configurable elements can be individually addressed to alter the direction of a wavefront that impinges on each element. RIS reflection properties (such as beam direction, beam width, frequency shift, amplitude, and polarization) are controlled by RF wavefront manipulation that is controllable at the element level, for example via the bias voltage at each element to change the phase of the reflected wave. This control signal forms a pattern at the RIS. To change the RIS reflective or redirecting behavior, the RIS pattern needs to be changed.

Connections between the RIS and a UE can take several different forms. In some embodiments, the connection between the RIS and the UE is a reflective channel where a signal from the BS is reflected, or redirected, to the UE or a signal from the UE is reflected to the BS. In some embodiments, the connection between the RIS and the UE is a reflective connection with passive backscattering or modulation. In such embodiments a signal from the UE is reflected by the RIS, but the RIS modulates the signal by the use of a particular RIS pattern. Likewise, a signal transmitted from the BS may be modulated by the RIS before it reaches the UE. In some embodiments, the connection between the RIS and the UE is a network controlled sidelink connection. This means that that the RIS may be perceived by the UE as another device like a UE, and the RIS forms a link similar to two UEs, which is scheduled by the network. In some embodiments, the connection between the RIS and the UE is an ad hoc in-band/out-of-band connection.

A RIS device, also referred to as a RIS panel, is generally considered to be the RIS and any electronics that may be used to control the configurable elements and hardware and/or software used to communication with other network nodes. However, the expressions RIS, RIS panel and RIS device may be used interchangeably in this disclosure to refer to the RIS device used in a communication system.

The processing unit 285 implements various processing operations of the RIS 182, such as receiving the configuration signal via interface 290 and providing the signal to the controller 293. The processing unit 285 could, for example, include a microprocessor, microcontroller, digital signal processor, field programmable gate array, or application specific integrated circuit.

While this is a particular example of an RIS, it should be understood that the RIS may take different forms and be implemented in different manner than shown in FIG. 3B. The RIS 182 ultimately needs a set of configurable elements that can be configured as described to operate herein.

FIG. 3B illustrates an interface 290 to receive configuration information from the network. In some embodiments, the interface 290 enables a wired connection to the network. The wired connection may be to a base station or some other network-side device. In some embodiments, the wired connection is a proprietary link, i.e., a link that is specific to a particular vendor or supplier of the RIS equipment. In some embodiments, the wired connection is a standardized link, e.g., a link that is standardized such that anyone using the RIS uses the same signaling processes. The wired connection may be an optical fiber connection or metal cable connection.

In some embodiments, the interface 290 enables a wireless connection to the network. In some embodiments, the interface 290 may include a transceiver that enables RF communication with the BS or with the UE. In some embodiments, the wireless connection is an in-band proprietary link. In some embodiments, the wireless connection is an in-band standardized link. The transceiver may operate out of band or using other types of radio access technology (RAT), such as Wi-Fi or BLUETOOTH. In some embodiments, the transceiver is used for low rate communication and/or control signaling with the base station. In some embodiments, the transceiver is an integrated transceiver such as an LTE, 5G, or 6G transceiver for low rate communication. In some embodiments, the interface could be used to connect a transceiver or sensor to the RIS.

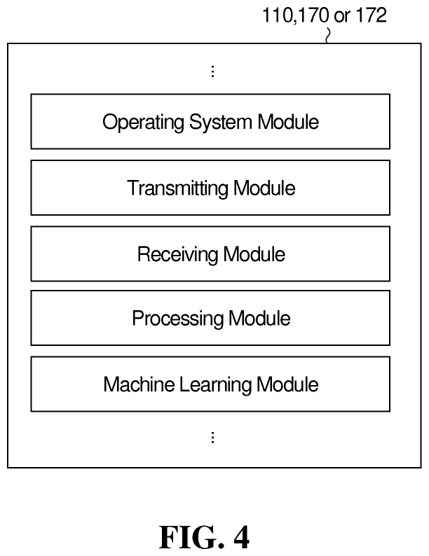

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

For future wireless networks, a number of the new devices could increase exponentially with diverse functionalities. Also, many new applications and new use cases in future wireless networks than existing in 5G may emerge with more diverse quality of service demands. These will result in new key performance indications (KPIs) for the future wireless network (for an example, 6G network) that can be extremely challenging, so the sensing technologies, and AI technologies, especially ML (deep learning) technologies, had been introduced to telecommunication for improving the system performance and efficiency.

AI/ML technologies applied communication including AI/ML communication in Physical layer and AI/ML communication in media access control (MAC) layer. For physical layer, the AI/ML communication may be useful to optimize the components design and improve the algorithm performance, like AI/ML on channel coding, channel modelling, channel estimation, channel decoding, modulation, demodulation, MIMO, waveform, multiple access, PHY element parameter optimization and update, beam forming & tracking and sensing & positioning, etc. For MAC layer, AI/ML communication may utilize the AI/ML capability with learning, prediction and make decisions to solve the complicated optimization problems with better strategy and optimal solution, for example to optimize the functionality in MAC, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

AI/ML architectures usually involve multiple nodes, which can be organized in two modes, i.e., centralized and distributed, both of which can be deployed in access network, core network, or an edge computing system or third-party network. The centralized training and computing architecture is restricted by huge communication overhead and strict user data privacy. Distributed training and computing architecture comprise several frameworks, e.g., distributed machine learning and federated learning. AI/ML architectures comprises intelligent controller which can perform as single agent or multi-agent, based on joint optimization or individual optimization. New protocol and signaling mechanism is needed so that the corresponding interface link can be personalized with customized parameters to meet particular requirements while minimizing signaling overhead and maximizing the whole system spectrum efficiency by personalized AI technologies.

Further terrestrial and non-terrestrial networks may enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial network based sensing and non-terrestrial network based sensing may involve opportunities for localization and sensing applications based on a new set of features and service capabilities. Applications such as Terahertz (THz) imaging and spectroscopy have the potential to provide continuous, real-time physiological information via dynamic, non-invasive, contactless measurements for future digital health technologies. Simultaneous localization and mapping (SLAM) methods may not only enable advanced cross reality (XR) applications but may also enhance the navigation of autonomous objects such as vehicles and drones. Further in terrestrial and non-terrestrial networks, measured channel data and sensing and positioning data may be obtained by large bandwidth, additional spectrum, dense network and additional light-of-sight (LOS) links. Based on these data, a radio environmental map may be determined through AI/ML methods, where channel information is linked to its corresponding positioning or environmental information to provide an enhanced physical layer design based on this map.

Sensing coordinators are nodes in a network that may assist in the sensing operation. These nodes may be standalone nodes dedicated to just sensing operations or other nodes (for example TRP 170, ED 110, or core network node) doing the sensing operations in parallel with communication transmissions. A new protocol and signaling mechanism may be needed so that the corresponding interface link may be performed with customized parameters to meet particular requirements while minimizing signaling overhead and maximizing the whole system spectrum efficiency.

AI/ML and sensing methods are data intensive. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments described herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g., uplink control information (UCI) sent in a PUCCH or PUSCH or downlink control information (DCI) sent in a PDCCH. A dynamic indication may be an indication in a lower layer, e.g., physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g., physical layer control signaling sent in the physical layer, such as DCI sent in a PDCCH or UCI sent in a PUCCH or PUSCH.

As noted above, new nodes are introduced in wireless communications network. A non-limiting example of the new nodes is a reconfigurable intelligent surface (RIS). RIS has recently received heightened research interest as potentially being a key enabler for future wireless networks to meet requirements of high data rate and high bandwidth. The RIS consists of an array of configurable elements that can manipulate the phase, amplitude, polarization, and/or frequency of incident waves/signals. For example, a RIS element can manipulate the phase of an incident wave/signal to redirect the signal in a given direction. Such manipulations can be achieved by configuring the RIS elements via bias voltages (or other methods like mechanical deformation and phase change materials), that are controlled by a control circuit connected to the RIS. Therefore, for beamforming, the RIS elements may be configured to manipulate the phase, amplitude, polarization and/or frequency of the incident wave/signal, to modulate the incident wave/signal and forward the modulated wave/signal in a desired direction towards the destination.

In wireless communications network in which new nodes like RISs are employed, certain network communications may need to be performed while taking into consideration of properties and behaviours of the new nodes. For example, in a wireless network in which an RIS is employed, an apparatus that performs small data transmission (SDT) during an inactive state may need to consider properties and operation of the RIS to ensure that a signal carrying the data is received by a destination device. Some properties and operational characteristics of the RIS to consider in connection with the SDT may include:
An RIS may operate over specific bandwidth.
An RIS may manipulate phase, amplitude, polarization, and/or frequency of an incident wave/signal as the signal is redirected.
An RIS may be configured to operate differently over different time resources. For example, an RIS may be configured to be operatively associated with a first apparatus (e.g., user equipment (UE)) over a first time period so that the first apparatus may communicate with a network device (e.g., base station (BS)) during the first time period, and also configured to be operatively associated with a second apparatus over a second time period so that the second apparatus may communicate with the same or a different device during the second time period.

In a case where an SDT is performed via the configured grant based SDT (CG-SDT), the properties and operation of an RIS employed in a network may affect the configured grant (CG) scheduling for an apparatus performing the CG-SDT during an inactive state (e.g., radio resource control (RRC) inactive (RRC_INACTIVE) state). Therefore, an apparatus (e.g., UE, or chip/chipset/communication module in the UE) and a network device (BS) in the network may need to consider the properties and/or operation of an RIS, when the apparatus is to receive signals redirected by the RIS and attempts to transmit data to the network device while it remains in an inactive state (e.g., RRC_INACTIVE; in the present disclosure, for the purpose of illustration, in some embodiments, the inactive state may refer to RRC_INACTIVE state). It should be noted that, hereinafter, the terms “apparatus” and “network device” may be simply used to more easily distinguish between the entities. “Apparatus”, hereinafter, may include the ED 110 illustrated above, and may refer to any suitable end user device or UE for wireless operation and may include devices such as (but not limited to) a smartphone, a laptop, a computer, a tablet, a wireless sensor, a consumer electronics device, a smart book, a vehicle, a car, a truck, a bus, a train, an IoT device, an industrial device, a cellular telephone, a station (STA), a machine type communication (MTC) device, a personal digital assistant (PDA), a wireless transmit/receive unit (WTRU), a mobile station, a fixed or mobile subscriber unit, or an apparatus (e.g. communication module, modem, or chip) in any of the foregoing devices. “Network device”, hereinafter, may refer to a base station or any similar type of network side device or apparatus therein, and may include the base station 170a and 170b, T-TRP 170, and/or NT-TRP 172 illustrated above.

In the present disclosure, an apparatus may be considered to be served by the RIS when an apparatus is capable of receiving a signal redirected by the RIS. In the present disclosure, an RIS may be considered to serve an apparatus or a network device when the RIS acts to redirect a signal to the apparatus or the network device. In the present disclosure, an apparatus may be considered to be covered by an RIS when an apparatus is within a coverage area of the RIS so that the apparatus may be served by the RIS. In the present disclosure, an area covered by the RIS may be considered an area within which the RIS is able to redirect a signal to the apparatus, and may be referred to as a coverage area of the RIS.

Further details will be discussed below and elsewhere in the present disclosure with various examples.

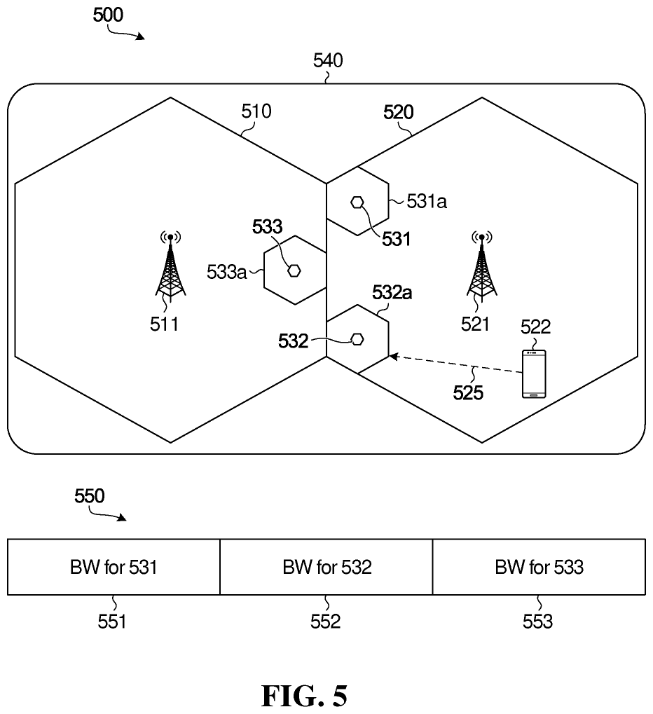

FIG. 5 illustrates a portion of an example wireless communication network 500 including multiple reconfigurable intelligent surfaces (RISs) that operate at different bandwidths, in accordance with embodiments of the present disclosure.

The network 500 may include network devices 511 and 521, an apparatus 522, a first RIS 531, a second RIS 532, and a third RIS 533. In the example of FIG. 5, the network devices 511 and 521 are base stations (BSs) and the apparatus 522 is a user equipment (UE). In the network 500, there may be a radio access network (RAN) based notification area (RNA) 540. The RAN 540 may include a first cell area 510 served by the network device 511 and a second cell area 520 served by the network device 521. The first cell area 510 may be an area different from the second cell area 520. The first cell area 510 may include a third RIS coverage area 533a, and the second cell area 520 may include a first RIS coverage area 531a and a second RIS coverage area 532a. It is noted that although the first cell area 510, the second cell area 520, the first RIS coverage area 531a, the second RIS coverage area 532a, and the third RIS coverage area 533a are illustrated as hexagons in FIG. 5, the shape of each of these cell areas or RIS coverage areas may be in any kind of shape (e.g., circular or elliptical shape). It is also noted that, although not explicitly illustrated in FIG. 5, different cell areas (e.g., first cell area 510 and/or second cell area 520) may overlap.

The network device 511 may serve the first cell area 510 and provide services and coverages to one or more apparatuses (not shown in FIG. 5) within the first cell area 510. In the network 500, the third RIS 533 is positioned within the third RIS coverage area 533a. Accordingly, as the third RIS coverage area 533a is included in the first cell area 510, the third RIS 533 is within the first cell area 510, the network device 511 may communicate with the third RIS 533, for example using a wired or wireless connection. The network device 511 may utilize the third RIS 533 to serve an apparatus within the third RIS coverage area 533a. The network device 521 may serve the second cell area 520 and provide services and coverages to one or more apparatuses within the second cell area 520, such as the apparatus 522. In the network 500, given that the apparatus 522 is located within the second cell area 520 at a given point in time, the network device 521 may communicate with the apparatus 522. In other words, the network device 521 may provide services and coverages to the apparatus 522. In the network 500, the first RIS 531 is located within the first RIS coverage area 531a and the second RIS 532 is located within the second RIS coverage area 532a. Accordingly, as the first and second RIS coverage areas 531a and 532a are included in the second cell area 520, the first RIS 531 and the second RIS 532 are within the second cell area 520, and the network device 521 may communicate with the first RIS 531 and/or second RIS 532, for example using a wired or wireless connection to configure the first RIS 531 and/or second RIS 532 for one or more purposes. For example, the network device 521 may send commands or control signals to the first RIS 531 and/or second RIS 532 via a wired or wireless connection. The network device 521 may utilize the first RIS 531 or the second RIS 532 to serve an apparatus within the first RIS coverage area 531a or the second RIS coverage area 532a.

The apparatus 522 may move within the second cell area 520, a particular direction of movement indicated by an arrow 525 in FIG. 5. While the location of the apparatus 522 remains within the second cell area 520, the apparatus 522 is generally served and provided coverage by the network device 521. As the apparatus 522 gets closer to the boundary between the first cell area 510 and the second cell area 520, it is possible that the apparatus 522 is served by both the network devices 511 and 521. When the apparatus 522 moves outside of the second cell area 520 and enters into the first cell area 510, the apparatus 522 may generally be served and provided coverage by the network device 511.

The apparatus 522 may communicate with a network device (e.g., network device 521) using one or more RISs within the RNA 540, for one or more reasons. For example, while not illustrated in FIG. 5, if the apparatus 522 is located within the first RIS coverage area 531a or the second RIS coverage area 532a, then the apparatus 522 and the network device 521 may communicate with each other using the first RIS 531 or the second RIS 532, respectively. In another example, if the apparatus 522 is located outside but close to the first RIS coverage area 531a or the second RIS coverage area 532a, and communication between the apparatus 522 and the network device 521 is interrupted or hampered by one or more obstacles (not shown in FIG. 5) between the apparatus 522 and the network device 521 (accordingly signals received via the first RIS 531 or second RIS 532 are stronger than signals received directly from the apparatus 522 or the network device 521), then the apparatus 522 and the network device 521 may communicate with each other using the first RIS 531 or the second RIS 532.

The first RIS 531, second RIS 532, and third RIS 533 may operate at different bandwidths (frequency ranges). Referring to FIG. 5, a representation of a total bandwidth 550 that is available for use by the first RIS 531, second RIS 532, and third RIS 533 for the SDT is shown. While the total bandwidth 550 is shown to be equally divided into three frequency bands in FIG. 5, it is understood that the bands do not need to be equally divided, and more generally, a number of bandwidth parts may be equal to the number of RISs sharing the allocated bandwidth (e.g., RISs sharing the total bandwidth 550). It is also understood that a number of bandwidth parts may be greater or less than the number of RISs sharing the allocated bandwidth (e.g., RISs sharing the total bandwidth 550; the total bandwidth may also be referred to as total frequency band or total frequency range). The total bandwidth 550 may be greater than or equal to the union of the first bandwidth (BW) 551, second bandwidth 552, and third bandwidth 553. It is noted that “BW” in FIG. 5 refers to bandwidth. The first RIS 531 may operate only at the first bandwidth (frequency range) 551, the second RIS 532 may operate only at the second bandwidth (frequency range) 552, and the third RIS 533 may operate only at the third bandwidth (frequency range) 553. Therefore, for example, when the apparatus 522 is within the first RIS coverage area 531a served by the first RIS 531, the apparatus 522 may communicate with the network device 521 over frequency resources that correspond to the first bandwidth 551. Similarly, when the apparatus 522 is within the second RIS coverage area 532a served by the second RIS 532, the apparatus 522 may communicate with the network device 521 over frequency resources that correspond to the second bandwidth 552. When the apparatus 522 moves outside of the second cell area 520 and enters into the first cell area 510, particularly the RIS coverage area 533a served by the third RIS 533, the apparatus 522 may communicate with the network device 511 using the third RIS 533 over frequency resources that correspond to the third bandwidth 553. Furthermore, when the apparatus 522 is not near any RIS or within an RIS coverage area, the apparatus 522 may communicate directly with the network device 511 or the network device 521. While the respective RISs are described above as operating “only at” a given bandwidth, it should be understood that the bandwidths may be configured for use over a particular duration of time, and then the bandwidths may be reconfigured for different bandwidths at a different time, depending on the needs of the various network devices. That is to say, the particular RISs are not necessarily limited to only operating in a same fixed bandwidth all the time. It is noted that the terms “duration” and “period” may refer to time length.

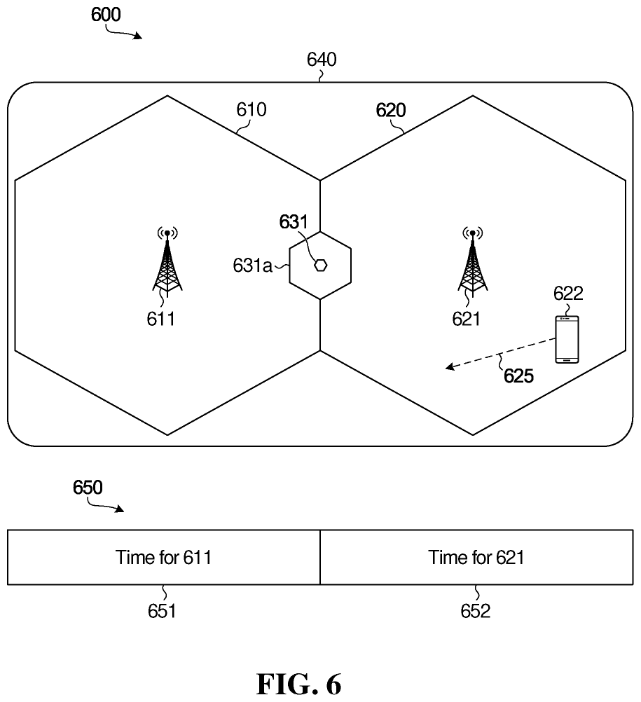

FIG. 6 illustrates a portion of an example wireless communication network 600 including an RIS that redirects signals to multiple network devices over different time resources, in accordance with embodiments of the present disclosure.

The network 600 may include network devices 611 and 621, an apparatus 622, an RIS 631. In the example of FIG. 6, the network devices 611 and 621 are base stations (BSs) and the apparatus 622 is a user equipment (UE). In the network 600, there may be a radio access network (RAN) based notification area (RNA) 640. The RAN 640 may include a first cell area 610 served by the network device 611 and a second cell area 620 served by the network device 621. The first cell area 610 may be an area different from the second cell area 620. The first cell area 610 may include a first portion of an RIS coverage area 631a, and the second cell area 620 may include a second portion of the RIS coverage area 631a. It is noted that although the first cell area 610, the second cell area 620, and the RIS coverage area 631a are hexagonal shapes in FIG. 6, the shape of each of these cell areas or RIS coverage area may be in any kind of shape (e.g., circular or elliptical shape).

The network device 611 may serve the first cell area 610 and provide services and coverage to one or more apparatuses (not shown in FIG. 6) within the first cell area 610. In the network 600, the RIS 631 is positioned within the RIS coverage 631a. Accordingly, as the RIS coverage area 631a is partly within the first cell area 610, the network device 611 may be connected to the RIS 631, for example using a wired or wireless connection. The network device 611 may utilize the RIS 631 to serve an apparatus within the first portion of the RIS coverage area 631a that is included in the first cell area 610 (i.e., area covered by the network device 611). The network device 621 may serve the second cell area 620 and provide services and coverage to one or more apparatuses within the second cell area 620, such as the apparatus 622. In the network 600, given that the apparatus 622 is located within the second cell area 620, at a given point in time, the network device 621 may provide services and coverage to the apparatus 622. In the network 600, as noted above, the RIS 631 is positioned within the RIS coverage 631a. Accordingly, as the RIS coverage area 631a is partly within the second cell area 620, and the network device 621 may communicate with the RIS 631, for example using a wired or wireless connection. The network device 621 may utilize the RIS 631 to serve the apparatus 622 located within the second portion of the RIS coverage area 631a that is included in the second cell area 620 (i.e., area covered by the network device 621). It is noted that the network device 611 may utilize the RIS 631 to serve an apparatus that was located within the first cell area 610 but moves to the second cell area 620 (i.e., area covered by the network device 621), if that apparatus is covered and/or served by the RIS 631. Likewise, the network device 621 may utilize the RIS 631 to serve an apparatus that was located within the second cell area 620 but moves to the first cell area 610 (i.e., area covered by the network device 611), if that apparatus is covered and/or served by the RIS 631. This may facilitate soft-handover process and alleviate handover ping-pong problem.

The apparatus 622 may move within the second cell area 620, a particular direction of movement indicated by an arrow 625 in FIG. 6. While the location of the apparatus 622 remains within the second cell area 620, the apparatus 622 is generally served and provided coverage by the network device 621. As the apparatus 622 gets closer to the boundary between the first cell area 610 and the second cell area 620, it is possible that the apparatus 622 is served by both the network devices 611 and 621. When the apparatus 622 moves outside of the second cell area 620 and enters into the first cell area 610, the apparatus 622 may generally be served and provided coverage by the network device 611.

The apparatus 622 may communicate with a network device (e.g., network device 621) using one or more RISs (e.g., RIS 631) within the RNA 640, for one or more reasons. For example, while not illustrated in FIG. 6, if the apparatus 622 is located within the second portion of the RIS coverage area 631a included in the second cell area 620, then the apparatus 622 and the network device 621 may communicate with each other using the RIS 631. In another example, if the apparatus 622 is located outside but close to the second portion of the RIS coverage area 631a included in the second cell area 620 (the apparatus 622 is within the second cell area 620 and therefore served by the network device 621), and communication between the apparatus 622 and the network device 621 is interrupted or hampered by one or more obstacles (not shown in FIG. 6) between the apparatus 622 and the network device 621 (accordingly signals received via the RIS 631 are stronger than signals received directly from the apparatus 622 or the network device 621), then the apparatus 622 and the network device 621 may communicate with each other using the RIS 631.

The RIS 631 may operate to serve different network devices at different time resources. Referring again to FIG. 6, the RIS 631 may operate over the total time resource 650 and serve either the network device 611 or 621. The RIS 631 may serve only one of the network devices 611 and 621 at one time. Specifically, the RIS 631 may serve the network device 611 during the time period represented by the time resource 651. During this time period, the RIS 631 may not serve the network device 621, and therefore the apparatus 622 may not communicate with the network device 621 via the RIS 631. Instead, the apparatus 622 may communicate with the network device 621 only directly, during the time period required by the time resource 651. The RIS 631 may serve the network device 621 during the time period represented by the time resource 652. During this time period, the RIS 631 may not serve the network device 611. The apparatus 622 may be able to communicate with the network device 621 via the RIS 631 during the time period represented by the time resource 652. While the total time resource 650 is shown to be equally divided into two time periods in FIG. 6, it is understood that the time periods do not need to be equally divided, and more generally, a number of divided time periods may be equal to the number of RIS sharing the allocated overall time period (e.g., RISs sharing the total time resource 650). It is also understood that a number of divided time periods may be greater or less than the number of RISs sharing the allocated overall time period (e.g., RISs sharing the total time resource 650). Furthermore, it should be understood that the time periods may be configured for use over a particular duration of time, and then the time periods may be reconfigured for different time periods at a different time, depending on the needs of the various network devices. That is to say, the particular RISs are not necessarily limited to only operating in a same fixed time period all the time. It is to be understood that it is also possible to divide the RIS coverage area into multiple RIS sub-regions such that the RIS serves multiple network devices at the same time. For example, the RIS may redirect, to the first network device, certain signals associated with the first one or more RIS sub-regions, and redirect, to the second network device, other signals associated with the second one or more RIS sub-regions that are different from the first one or more RIS sub-regions.

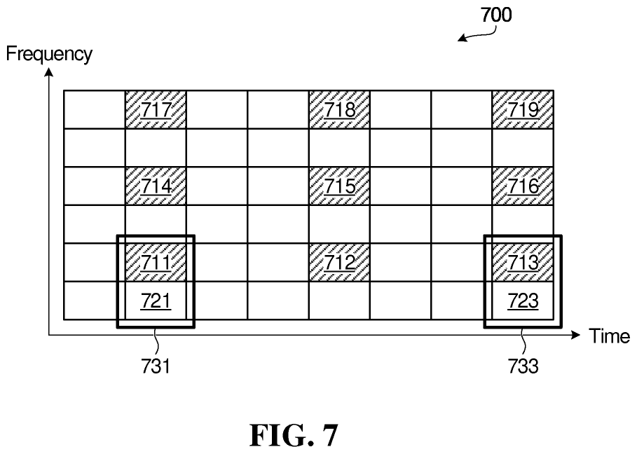

FIG. 7 illustrates an example configured grant (CG) configuration 700 for time frequency resources for a communication between an apparatus and a network device in a wireless communication network. The CG configuration 700 may illustrate the time frequency resources that may be used for the SDT. As noted above, in the present disclosure, “time frequency resource” or any similar term may refer to time resource, frequency resource, and/or time and frequency resource. The time frequency resources that may be used for the SDT may be referred to as CG resources. Generally, in addition to the resources, it should be understood that the CG configuration may include other information like the packet size, as well as the MCS or set of allowed MCS values.

The CG configuration 700 includes a number of resources that may be used for various communications in the network. Each rectangle, several of which are identified as blocks 711 to 719, within the CG configuration 700 may represent a time frequency resource. The time domain is shown in the horizontal direction and the frequency domain is shown in the vertical direction. The granularity of the time resource may be a slot, multiple slots, a symbol or multiple symbols. The granularity of the frequency resource may be a sub-carrier or multiple sub-carriers. The rectangles illustrated in FIG. 7 may collectively form total resources or total time frequency resources that are available for communications between various apparatuses and network devices within the network over a particular duration of time.

The CG configuration 700 may be associated with one or multiple signals (e.g., synchronization signal blocks (SSBs)). For example, a network device (e.g., BS) may transmit an SSB via a beam, and an apparatus (e.g., UE) may detect the SSB. Based on the detected SSB (e.g., using a SSB index associated with the detected SSB), the UE may be able to determine resources associated with the CG configuration 700 that was previously provided to the apparatus, for example via an RRC release message. Then, the apparatus may use the resources associated with the CG configuration 700 for communication with a network device, which may be a network device that is same as or different from the one sending the SSB. It is noted that the network device may not need to transmit the SSB using the resource associated with the CG configuration 700. It should be understood that before receiving paging signals, the UE may detect SSB signals to synchronize with the RAN as the UE may be out of synchronization due to a long sleep period for the UE when in RRC_INACTIVE state. In the context of SDT, not all resources associated with the CG configuration 700 may be used for the SDT of a given apparatus (e.g., UE). In other words, an apparatus that is in an inactive state may be able to transmit, to a network device, data using certain resources that are allocated or allowed for the SDT (e.g., CG-SDT). The resources that may be allocated for the SDT of a given apparatus may be referred to as CG resources for that apparatus.

In one example scenario, referring to FIGS. 5 and 7, the apparatus 522 may transmit a small amount of data directly to the network device 521, while the apparatus 522 remains in an inactive state and neither of the first RIS 531 or the second RIS 532 may be involved with communication between the apparatus 522 and the network device 521. In this case, the CG resources allocated for the SDT of the apparatus 522 may be resources 711, 712, 713, 714, 715, 716, 717, 718, and 719. When the apparatus 522 is in an inactive state and transmits a signal carrying small data over any of the resources 711, 712, 713, 714, 715, 716, 717, 718, and 719, then the signal may be properly received by the network device 522.

However, the CG resources for SDT when an apparatus transmits data to a network device via an RIS may be different from the CG resources for SDT when the same apparatus transmits data directly to the same network device (i.e., transmitting without any RISs).

For example, referring again to FIGS. 5 and 7, the apparatus 522 may move within the second cell area 520. At a different location, the apparatus 522 may communicate with the network device 521 via the RIS 532. In other words, a signal from the apparatus 522 may be received by the second RIS 532, then redirected by the second RIS 532 to the network device 521. When the network device 521 knows that apparatus 522 is within the coverage area of the second RIS 532 (the second RIS coverage area 532a), the second RIS 532 may be configured to operate using the resources within the boxes 731 and 733, namely resources 711, 721, 713, and 723. In other words, the resources that are suitable for redirection by the second RIS 532 may be the resources 711, 721, 713, and 723. Therefore, when the apparatus 522 is in an inactive state and communicates with the network device 521 using the second RIS 532, the apparatus 522 may perform the SDT using the resources 711 or 713, because the SDT is performed using resources that are allocated for SDT and enable the operation of the second RIS 532. If other CG resources are used, the data transmitted by the apparatus 522 may not be received by the network device 521 via the second RIS 532. It is noted that when the network device 521 learns that the apparatus 522 is within the second RIS coverage area 532a and served by the second RIS 532 (which may operate on specific time frequency resources), the network device 521 may serve the apparatus 522 via the second RIS 532. For example, when the apparatus 522 is within the second RIS coverage area 532a and/or performs SDT, the network device 521 may inform the apparatus 522 of the CG resources 711, 712, 713, 714, 715, 716, 717, 718, and 719 allocated for the SDT of the apparatus 522. The network device 521 may inform the apparatus 522 before the apparatus is transitioned from the connected state to the inactive state. Then, among these CG resources, the apparatus 522 may use the resources 711 and/or 713, because, as noted above, these are the resources that are allocated for SDT and enable the operation of the second RIS 532. It should be understood that the network device 521 may configure the RIS 532 to redirect the possible signals from apparatus 522 to the network device 521 considering the CG resources assigned for apparatus 522 and associated with RIS 532. With such scenario, whenever the apparatus 522 is within the coverage area 532a and transmits signals, the signals will be redirected to the network device 521.

Therefore, given that properties and operation of an RIS may affect SDT of an apparatus, the CG configuration may be generated and/or updated taking into consideration of the properties and operation of the RIS associated with the apparatus, for example a bandwidth in which the RIS operates and/or a time period in which the RIS operates.

Aspects of the present disclosure provide solutions to overcome the potential issues described above, as well as specific methods, apparatuses, network devices, and systems for communications between apparatuses and network devices in a wireless network during an inactive state. In particular, methods, apparatuses, network devices, and systems that facilitate small data transmissions (SDT) between an apparatus (e.g., UE) and a network device (e.g., BS) during an inactive state (e.g., RRC_INACTIVE) using a CG configuration associated with one or more events, will be illustrated herein. Aspects of the present disclosure will be illustrated in the context of a wireless network in which one or more reconfigurable intelligent surfaces (RISs) are employed and an apparatus (e.g., UE) and a network device (e.g., BS) may communicate with each other via the one or more RISs. However, it should be noted that aspects of the present disclosure are not limited to networks in which an apparatus and a network device communicate with each other via one or more RISs, but may be applicable more broadly to other types of networks in which methods, apparatuses, network devices, and/or systems described herein may be implemented. In the present disclosure, the one or more RISs may be considered to include conventional RISs, intelligent reflecting surfaces, large intelligent surfaces, network-controlled repeaters, smart repeaters, holographic radios, and/or other similar types of network entities.

In some embodiments of the present disclosure, time frequency resources that may be allocated for an SDT of a given apparatus may be selected based on one or more RISs in an area in which the given apparatus and a network device communicating with the apparatus are located. In the present disclosure, in some embodiments, the area in which the apparatus and the network device are located may refer to 1) a cell area in which the apparatus received the RRC release message and transitioned to RRC_INACTIVE state or 2) an RNA. The time frequency resources that may be allocated for the transmissions during an inactive state (e.g., SDT) may be referred to as CG resources.

In some embodiments, before transitioning from a connected state (e.g., RRC_CONNECTED) to an inactive state (e.g., RRC_INACTIVE), an apparatus (e.g., UE) may receive a radio resource control (RRC) message from a network device (e.g., BS) or a network. The RRC message may be a message that triggers the apparatus to transition from a connected state to an inactive state. For example, the RRC message may be an RRCRelease message with suspendConfig parameters. The suspendConfig parameters in RRCRelease message may configure operation of the apparatus, which receives the RRCRelease message, during an inactive state (e.g., RRC_INACTIVE), and include parameters such as an inactive radio network temporary identifier (I-RNTI) (e.g., full and/or short I-RNTI) and/or discontinuous reception (DRX) parameters (e.g., DRX cycle, and “on” duration), radio access network (RAN) based notification area (RNA), RNA up-date timer (e.g., t380 timer). The RRC message may also include information pertaining to configured grant (CG) configurations. The information pertaining to CG configurations may be used for determining a CG configuration to be used by the apparatus for transmission of a signal during an inactive state (e.g., SDT). The determined CG configuration may be associated with one or more events within an area in which the apparatus and the network device are located. In the present disclosure, in some embodiments, the area in which the apparatus and the network device are located may refer to 1) a cell area in which the apparatus received the RRC release message and transitioned to RRC_INACTIVE state or 2) an RNA. The CG configuration may include a CG resource associated with the one or more events. In some embodiments, the one or more events may be associated with at least one of the RIS within the area or a location of the apparatus within the area.

In one example, the event may be related to detection of an RIS within the area in which the apparatus and the network device are located. The apparatus may detect the RIS within the area based on paging signals that the apparatus receives from the network device and/or based on a location of the apparatus within the area. It is noted that the apparatus may be within an area covered by the RIS, e.g., a coverage area of the RIS or an area within which the RIS is able to redirect a signal to the apparatus. Upon detecting the RIS, the apparatus may select a specific CG configuration that is associated with the RIS, so that the apparatus, during the inactive state, may transmit data to the network device via the RIS.

In some embodiments of the present disclosure, a CG configuration for an apparatus (e.g., UE) may be updated based on its proximity to an RIS in an area in which the given apparatus and a network device communicating with the apparatus are located. In some embodiments of the present disclosure, the CG configuration for the apparatus may be updated based on a paging signal that the apparatus receives from the network device via the RIS.

In some embodiments, while an apparatus is in an inactive state, the location of the apparatus may be determined using various methods. For example, the apparatus (e.g., UE) may transmit, to the network device (e.g., BS), a sounding reference signal (SRS) that may enable the network device to determine the location of the apparatus, and the network device may determine the location of the apparatus based on the SRS transmitted from the apparatus.

The network device may determine whether the apparatus is located within an area covered by the RIS (coverage area of the RIS). After the network device determines that the apparatus is located within the area covered by the RIS, the network device may configure the RIS such that the signal transmitted from the apparatus is to be redirected to the network device. The network device may configure the RIS considering the CG configuration to be used by the apparatus. When the apparatus has small data to send to the network device during an inactive state, the apparatus may perform an SDT using the time frequency resources associated with the CG configuration that are available for the SDT.

In some embodiments of the present disclosure, a CG configuration for an apparatus (e.g., UE) may be determined or updated to perform multiple SDTs (e.g., perform an SDT and then perform one or more subsequent SDTs). The CG configuration may be determined or updated in consideration of operation of the RIS.

In some embodiments, an RIS may serve multiple network devices (e.g., multiple BSs) over different time resources. For example, an RIS may serve a network device over a particular time slot and serve another network device over a different time slot. In such a case, subsequent SDTs from the apparatus to the network device may need to be performed in consideration of operation of the RIS.

In some embodiments, the network device may transmit, to the apparatus, information indicative of at least one of: which CG configuration is to be used for the subsequent SDT(s), a maximum number of the one or more subsequent SDTs, or a direction in which the apparatus is to perform the subsequent SDTs during a time period that the RIS is not configured to redirect a signal to the network device. When the RIS does not redirect a signal to the network device, the apparatus may need to transmit the data directly to the network device, for example using a LOS path, or another path not via the RIS. The above information may be transmitted to the apparatus within the CG resources that may be used for the apparatus.

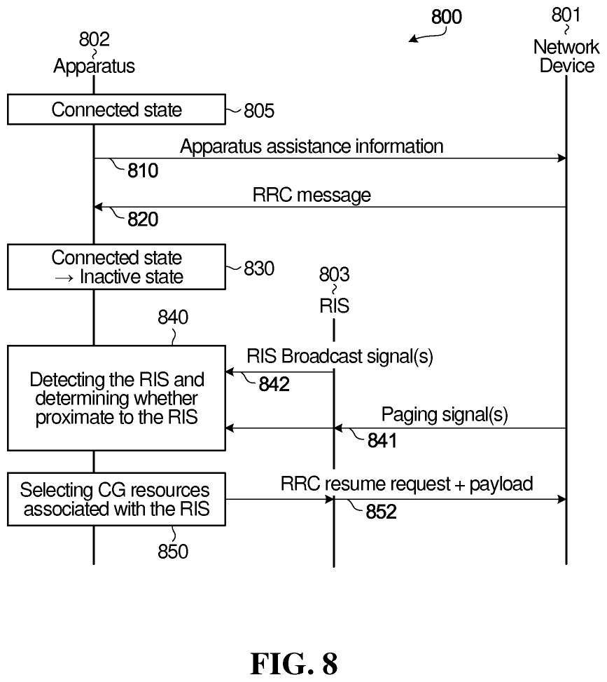

FIG. 8 is a signal flow diagram illustrating an example method 800 for communication between an apparatus 802 and a network device 801 where the apparatus 802 is in an inactive state and is located within an area capable of receiving a signal redirected by an RIS 803 that operates within a certain bandwidth, in accordance with embodiments of the present disclosure.

The example method 800 is comprised of steps 805, 810, 820, 830, 840, 841, 842, 850, and 852. Some of these steps may be optional. It should be understood that, in some embodiments, the order of one or more steps 805, 810, 820, 830, 840, 841, 842, 850, and 852 may be changed, but the general concept is maintained.

In some embodiments, the network device 801, the apparatus 802, and the RIS 803 shown in FIG. 8 may be employed in a network that is similar to the network 500 illustrated in FIG. 5. The apparatus 802 may be located within an area covered by the RIS 803. The apparatus 802 may perform an SDT using a CG configuration associated with the RIS 803 while the apparatus 802 is in an inactive state (e.g., RRC_INACTIVE). In some embodiments, the network device 801 may be a BS and the apparatus 802 may be a UE.

Referring to FIG. 8, at step 805, the apparatus 802 is initially in a connected state (e.g., RRC_CONNECTED). A connection between the network device 801 and the apparatus 802 has been established, and the network device 801 has configured the apparatus 802 with at least some parameters needed for communication between them.

At step 810, which is prior to transitioning from a connected state (e.g., RRC_CONNECTED) to an inactive state (e.g., RRC_INACTIVE), the apparatus 802 may transmit via RRC signaling (e.g. apparatus assistance information, which may be considered UE assistance information if the apparatus 802 is a UE) for example, to the network device 801, a signal to inform the network device 801 that the apparatus 802 prefers to transition to the inactive state and to request configured grant (CG) configurations.

At step 820, the network device 801 may transmit, to the apparatus 802, a radio resource control (RRC) message that triggers the apparatus 802 to transition from the connected state to the inactive state. The RRC message may be an RRC release message with suspended configuration parameters. The suspended configuration parameters may facilitate the operation of the apparatus 802 during the inactive state. The suspended configuration parameters may include an inactive radio network temporary identifier (I-RNTI) (e.g., full and/or short I-RNTI) and/or discontinuous reception (DRX) parameters (e.g., DRX cycle, and “on” duration), RNA, RNA up-date timer (e.g., t380 timer). The RRC message may further include information pertaining to configured grant (CG) configurations indicating one or more resources that are available to be used by the apparatus 802 for the communication with the network device 801. The information pertaining to CG configurations may be or may not be a part of the suspended configuration parameters. It is noted that in some embodiments, step 820 may be performed without performing step 810. For example, in step 820, the apparatus 802 may detect that there is no, or not a significant amount of, data transmission and may decide to transition to an inactive state. In another example, the network device 801 (e.g., BS) or network may also detect no, or not a significant amount of, data transmission, and may decide to trigger the apparatus 802 to transition to the inactive state.

The information pertaining to CG configurations may include at least one of: one or more CG configurations for the communication with the network device 801, one or more CG configurations associated with the one or more events in an area in which the network device 801 and the apparatus 802 are located, or information indicative of how to detect the RIS. In the present disclosure, the information indicative of how to detect the RIS may include information identifying one or more methods that can be used to detect whether the RIS is or can be used in a path from the network device to the apparatus. It should be noted that the term “method” or the likes being used in the present disclosure in connection with detecting an RIS may not correspond to a definite multi-step method, but more generally how an RIS can be detected.

In some embodiments, the one or more CG configurations associated with the one or more events in the area may include at least one of: information indicative of frequency bands associated with different (or respective) RISs within the area, or information indicative of one or more areas in which the apparatus 802 may receive redirected signals from different (or respective) RISs within the area.

In some embodiments, the information indicative of how to detect may specify one or more methods detecting an RIS. The method of detecting an RIS may include detecting an RIS based on one or more RIS broadcast signals transmitted from a certain type of RISs having active (physical) elements thereon within the area. It may be noted that a certain type of RISs may include active RIS elements that are connected to RFCs (RF chains). Such type of RISs may be able to send signals by themselves as well as redirect incident signals. The method of detecting an RIS may include detecting an RIS based on information indicative of areas covered by different (or respective) RISs within the area. The areas covered by the RISs may be detected by the apparatus 802, for example, using global positioning system (GPS) information determined by the apparatus 802 and/or a signal received from the network device 801. The method of detecting an RIS may include detecting the RIS based on an indication of the RIS included in a paging signal and/or SSB signal transmitted from the network device 801 to the apparatus 802. The indication of the RIS overlaid onto the paging signal and/or SSB signal via a media based modulation (MBM). For MBM, examples of overlaying for additional information (e.g., indication of a specific RIS) over the incident signal at RIS may comprise one of: modifying a phase shift of one or more configurable elements of the RIS to modulate at least one of amplitude, phase, frequency or polarization of the incident signal in order to overlay additional information on the incident signal; or turning one or more configurable elements of the RIS on or off to modulate the amplitude.

After receiving the RRC message, at step 830, the apparatus 802 may transition from the connected state to the inactive state.

At step 840, during the inactive state, the apparatus 802 may receive one or more paging signals 841 from the network device 801. In some embodiments, the apparatus 802 may detect an RIS 803 using information indicative of how to detect an RIS included in the information pertaining to CG configurations (included in the RRC message). Then, the apparatus 802 may determine whether the apparatus 802 is located proximate to the RIS 803. The apparatus 802 may determine whether the apparatus 802 is located proximate to the RIS 803 by detecting 842 signals broadcast by the RIS 803 (RIS broadcast signals) and/or an indication of the RIS 803 overlaid onto the paging signal via a media based modulation (MBM). The indication of the RIS 803 may be overlaid on the paging signal by the RIS 803.

If the apparatus 802 has small data (e.g., data having a size that is equal to or less than a particular data size) to transmit to the network device 801 during the inactive state, the apparatus 802, at step 850, may select time frequency resources (CG resources) associated with the RIS 803. The selected time frequency resource associated with the RIS 803 may be indicated as the CG resource in the CG configuration. If the selected time frequency resource (CG resource) associated with the RIS 803 is available, the apparatus 802 may send, to the network device 801, an RRC resume request message 852 (e.g., initial CG-SDT RRC resume request message) and payload data over the selected time frequency resource (CG resource) associated with the RIS 803.

While not explicitly illustrated in FIG. 8, after receiving the data from the apparatus 802, the network device 801 may send an RRC release message with suspended indication.

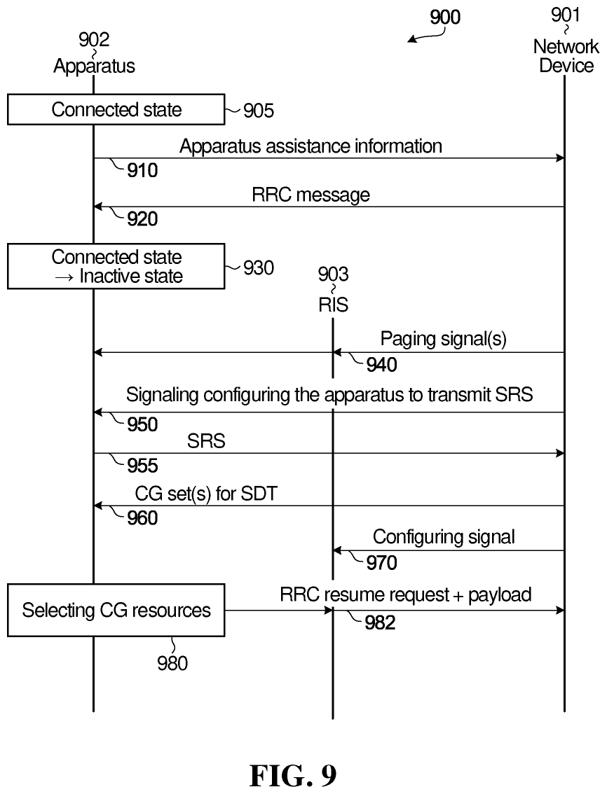

FIG. 9 is a signal flow diagram illustrating another example method 900 for communication between an apparatus 902 and a network device 901 where the apparatus 902 in an inactive state is located within an area capable of receiving a signal redirected by an RIS 903 that operates within a certain bandwidth, in accordance with embodiments of the present disclosure.

The example method 900 is comprised of steps 905, 910, 920, 930, 940, 950, 955, 960, 970, 980, and 982. Some of these steps may be optional. It should be understood that, in some embodiments, the order of one or more steps 905, 910, 920, 930, 940, 950, 955, 960, 970, 980, and 982 may be changed, but the general concept is maintained.

In some embodiments, the network device 901, the apparatus 902, and the RIS 903 shown in FIG. 9 may be employed in a network that is similar to the network 500 illustrated in FIG. 5. The apparatus 902 may be located within an area covered by an RIS 903. The network device 901 may configure the RIS 903 to redirect a signal transmitted from the apparatus 902 when performing the SDT, using the CG configuration for the apparatus 902. In some embodiments, the network device 901 may be a BS and the apparatus 902 may be a UE.

Referring to FIG. 9, at step 905, the apparatus 902 is initially in a connected state (e.g., RRC_CONNECTED). A connection between the network device 901 and the apparatus 902 is established, and the network device 901 has configured the apparatus 902 with at least some parameters needed for communication between them.

At step 910, which is prior to transitioning from a connected state (e.g., RRC_CONNECTED) to an inactive state (e.g., RRC_INACTIVE), the apparatus 902 may transmit via RRC signaling (e.g. apparatus assistance information, which may be considered UE assistance information if the apparatus 902 is a UE) for example, to the network device 901, a signal to inform the network device 901 that the apparatus 902 prefers to transition to the inactive state and to request configured grant (CG) configurations.

At step 920, the network device 901 may transmit, to the apparatus 902, a radio resource control (RRC) message that triggers the apparatus 902 to transition from the connected state to the inactive state. The RRC message may be an RRC release message with suspended configuration parameters. The suspended configuration parameters may facilitate the operation of the apparatus 902 during the inactive state. The suspended configuration parameters may include an inactive radio network temporary identifier (I-RNTI) (e.g., full and/or short I-RNTI) and/or discontinuous reception (DRX) parameters (e.g., DRX cycle, and “on” duration), RNA, RNA up-date timer (e.g., t380 timer). The RRC message may further include information pertaining to configured grant (CG) configurations indicating one or more resources that are available to be used by the apparatus 902 for the communication with the network device 901. The information pertaining to CG configurations may be or may not be a part of the suspended configuration parameters. It is noted that in some embodiments, step 920 may be performed without performing step 910. For example, in step 910, the apparatus 902 may detect that there is no, or not a significant amount (e.g. less than certain threshold) of, data transmission and may decide to transition to an inactive state. In another example, the network device 901 (e.g., BS) or network may also detect no, or not a significant amount (e.g. less than certain threshold) of, data transmission, and may decide to trigger the apparatus 902 to transition to the inactive state.

The information pertaining to CG configurations may include at least one of: one or more CG configurations for the communication with the network device 901, or one or more indications for one or more CG configurations that are available for use by the apparatus 902 to transmit the signal. In some embodiments, the one or more CG configurations for the communication with the network device 901 may be associated with different SSBs. In some embodiments, the one or more indications for one or more CG configurations that are available for use by the apparatus 902 to transmit the signal may be indices. For example, each CG configuration set available for use by the apparatus 902 to transmit the signal may be identified as, for example, set 1, set 2, set 3, . . . , etc.

After receiving the RRC message, at step 930, the apparatus 902 may transition from the connected state to the inactive state.

At step 940, during the inactive state, the apparatus 902 may receive one or more paging signals from the network device 901.

At step 950, the network device 901 may transmit a signal configuring the apparatus 902 to transmit a sounding reference signal (SRS) that may enable the network device 901 to determine the location of the apparatus 902. For example, the network device 901 may send a paging signal that triggers the apparatus 902 to transmit an SRS.

The apparatus 902, at step 955, may transmit the SRS to the network device 901 to enable the network device 901 to determine the location of the apparatus 902.

At step 960, the network device 901 may transmit, to the apparatus 902, one or more particular CG resource sets for use by the apparatus 902 for the SDT, or information indicative of the one or more particular CG resource set for use by the apparatus 902 for the SDT. In some embodiments, step 960 may be optional.

At step 970, the network device 901 may configure the RIS 903 such that a signal transmitted from the apparatus 902 is redirected to the network device 901, based on the CG configuration to be used by the apparatus 902. For example, the network device 901 may transmit a signal configuring the RIS 903 such that the signal from the apparatus 902 is redirected to the network device 901 based on the CG configuration determined for use by the apparatus 902 or the CG configuration that aligns with the particular CG resources or CG resource sets for use by the apparatus 902 for the SDT.

If the apparatus 902 has small data (e.g., data having a size that is equal to or less than a particular data size) to transmit to the network device 901 during the inactive state, the apparatus 902, at step 980, may select time frequency resources (CG resources) that are available for use by the apparatus 902 for the SDT. In some embodiments, at step 980, the apparatus 902 may select time frequency resources (CG resources) available for use by the apparatus 902 for the SDT, based on the indications for one or more CG configurations received at step 920. In some embodiments, at step 980, the apparatus 902 may select time frequency resources (CG resources) available for use by the apparatus 902 for the SDT, based on the one or more particular CG resource sets for use by the apparatus 902 for the SDT (or information indicative thereof) received at step 960. Then, the apparatus 902, at step 982, may initiate the SDT (e.g., CG-SDT) by sending, to the network device 901, an RRC resume request message (e.g., CG-SDT RRC resume request message) and payload data over the selected time frequency resource (CG resource).

While not explicitly illustrated in FIG. 9, after receiving the data from the apparatus 902, the network device 901 may send an RRC release message with suspended indication.

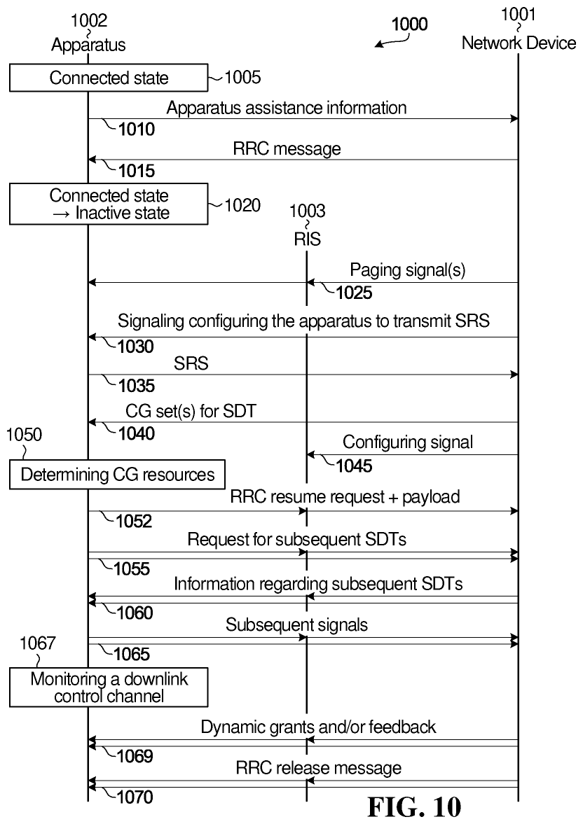

FIG. 10 is a signal flow diagram illustrating another example method 1000 for communication between an apparatus 1002 and a network device 1001 where the apparatus 1002 in an inactive state is located within an area capable of receiving a signal redirected by an RIS 1003 that redirects signals to multiple network devices over different time resources, in accordance with embodiments of the present disclosure.

The example method 1000 is comprised of steps 1005, 1010, 1015, 1020, 1025, 1030, 1035, 1040, 1045, 1050, 1052, 1055, 1060, 1065, 1067, 1069, and 1070. Some of these steps may be optional. It should be understood that, in some embodiments, the order of one or more steps 1005, 1010, 1015, 1020, 1025, 1030, 1035, 1040, 1045, 1050, 1052, 1055, 1060, 1065, 1067, 1069, and 1070 may be changed, but the general concept is maintained.

In some embodiments, the network device 1001, the apparatus 1002, and the RIS 1003 shown in FIG. 10 may be employed in a network that is similar to the network 600 illustrated in FIG. 6. The RIS 1003 may be positioned between a cell area covered by the network device 1001 and another cell area covered by another network side device. The RIS 1003 may support the communication between multiple network devices (e.g., BSs) and apparatuses (e.g., UEs) by serving different network devices at different time resources (e.g., different time slots) in a manner similar to those illustrated in FIG. 6 or 11. The SDT performed by the apparatus 1002 in an inactive state may be affected by such operation of the RIS 1003, especially during one or more subsequent transmissions, which may be one or more SDTs performed by the apparatus 1002 after the initial SDT. For example, while the apparatus 1002 performs one or more subsequent SDTs to the network device 1001 via the RIS 1003, the RIS 1003 may change its operation to serve another network device that is different from the network device 1001. In such cases, the apparatus 1002 may need to adapt the subsequent SDTs in a manner that ensures the signal is not transmitted to the RIS 1003. While the RIS 1003 serves the other network device that is different from the network device 1001, the apparatus may transmit the signal in a different direction, for example directly toward the network device 1001.

Referring to FIG. 10, steps 1005 to 1045 may be similar to steps 905 to 970 described above and in FIG. 9 of the present disclosure. Accordingly, details for these steps are not repeated here, except some potential differences discussed below.

In some embodiments, the information pertaining to CG configurations included in the RRC message at step 1015 may not be identical to the information pertaining to CG configurations included in the RRC message at step 920 of FIG. 9.

In some embodiments, the information pertaining to CG configurations included in the RRC message at step 1015 may include at least one of: one or more CG configurations for the communication with the network device 1001, one or more indications for one or more CG configurations that are available for use by the apparatus 1002 to transmit the signal, one or more CG configurations associated with the one or more events in an area in which the network device 1001 and the apparatus 1002 are located, or information indicative of how to detect an RIS. The “one or more CG configurations for the communication with the network device 1001” and the “one or more indications for one or more CG configurations that are available for use by the apparatus 1002 to transmit the signal” may be similar to those illustrated above with reference to step 920 of FIG. 9. The “one or more CG configurations associated with the one or more events in an area in which the network device 1001 and the apparatus 1002 are located” and the “information indicative of how to detect an RIS” may be similar to those illustrated above with reference to step 820 of FIG. 8. Therefore, details of these elements are not repeated here.

In some embodiments, at step 1040 which may be similar to step 960 of FIG. 9, the one or more particular CG resource sets transmitted by the network device 1001 to the apparatus 1002 may be determined in consideration of the operation time of the RIS 1003 (e.g., time that the RIS 1003 serves the network device 1001 and time that the RIS 1003 serves another network device).

In some embodiments, the apparatus 1002 may intend to transmit one or more subsequent signals after the initial SDT. In such cases, at step 1050, the apparatus 1002 may determine a time frequency resource (CG resource) that is available for the initial SDT based on the preconfigured CG configurations that are associated with the RIS 1003. Then, the apparatus 1002, at step 1052, may initiate the SDT (e.g., CG-SDT) by sending, to the network device 1001, an RRC resume request message (e.g., CG-SDT RRC resume request message) and payload data over the determined time frequency resource (CG resource).

At step 1055, the apparatus 1002 may transmit a buffer status reporting (BSR) to indicate a request for one or more subsequent transmissions (e.g., one or more subsequent SDTs).

After receiving the initial data and the request for the one or more subsequent transmissions (e.g., one or more subsequent SDTs) from the apparatus 1002, the network device 1001 may transmit, to the apparatus 1002, information regarding subsequent SDTs.

In some embodiments, the information regarding the one or more subsequent transmissions (e.g., one or more subsequent SDTs) may include a maximum number of the one or more subsequent transmissions may be determined in consideration of the operation of the RIS 1003 (e.g., maximum number of the one or more subsequent transmissions that may be performed while the RIS 1003 serves the network device 1001). In some embodiments, the information regarding the one or more subsequent transmissions (e.g., one or more subsequent SDTs) may include other information, as further illustrated below.

After receiving the information regarding the one or more subsequent transmissions, at step 1065, the apparatus 1002 may perform one or more subsequent SDTs. For example, the apparatus 1002 may transmit one or more subsequent signals to the network device 1001 directly or via the RIS 1003.

In some embodiments, if the network device 1001 knows the location of the apparatus 1002, the information regarding the one or more subsequent transmissions (e.g., one or more subsequent SDTs) that the apparatus 1002 receives at step 1060 may include information indicative of a direction in which the apparatus 1002 is to transmit the one or more subsequent signals during a time period that the RIS 1003 is not configured to redirect the one or more subsequent signals to the network device 1001. One example implementation is illustrated in FIG. 11.

FIG. 11 illustrates an example of how the apparatus 1002 may transmit a signal to the network device 1001 in a network 1100 where the RIS 1003 redirects signals to multiple network devices over different time resources, in accordance with embodiments of the present disclosure. The example illustrated in FIG. 11 may need to be considered in the context of the example method 1000 illustrated in FIG. 10. Each of the elements included in the network 1100 may be similar to those illustrated above and in FIG. 6 of the present disclosure. Accordingly, details for these elements are not repeated here. However, it should be noted that, in FIG. 11, the apparatus 1002 is located within a portion of the RIS coverage area 1003a that is included in the cell area 1001a served by the network device 1001. Accordingly, the network device 1001 may utilize the RIS 1003 to serve the apparatus 1002. Put another way, the network device 1001 and the apparatus 1002 may communicate to each other using the RIS 1003.

The RIS 1003 may operate to serve the network devices 1001 and 1101 at different time resources, as illustrated in FIG. 11. The RIS 1003 may operate over the total time resource 1150. The RIS 1003 may serve the network device 1101 during the time periods represented by the time resources 1151 and 1153, and serve the network device 1001 during the time period represented by the time resources 1152 and 1154. During the time period represented by the time resources 1152 and 1154, which are the time periods that the RIS 1003 serves the network device 1001, the apparatus 1002 may transmit signals using a beam 1112 so that the transmitted signal may be received by the network device 1001 via the RIS 1003. However, during the time periods represented by the time resources 1151 and 1153, which are the time periods that the RIS 1003 serves the network device 1101, the apparatus 1002 may transmit signals using a different beam 1111, which is directed toward the network device 1001 as illustrated in FIG. 11, because the RIS 1003 does not serve the network device 1001. In other words, when the RIS 1003 serves the network device 1101, the apparatus 1002 may use the beam 1111 to directly communicate with the network device 1001. In some embodiments, the direction in which the apparatus 1002 is to transmit the one or more subsequent signals may be a direction relative to the transmission direction to the RIS 1003.

In some embodiments, when the RIS 1003 serves the network device 1101, which are the time periods represented by the time resources 1151 and 1153, the apparatus 1002 may not use a different beam (e.g., beam 1111) to directly communicate with the network device 1001. Instead, the apparatus 1002 may not communicate with the network device 1001 when the RIS 1003 serves the network device 1101, because the apparatus 1002 may communicate with the network device 1001 via the RIS 1003. In such cases, during the subsequent transmissions (e.g., subsequent SDTs) at step 1065 of FIG. 10, the apparatus 1002 may adapt discontinuous reception (DRX) based on the operation of the RIS 1003, and monitor 1067 a downlink control channel during the (adapted) DRX to receive 1069 at least one of dynamic grants or feedback from the network device 1001. In some embodiments, the downlink control channel may be a physical downlink control channel (PDCCH).

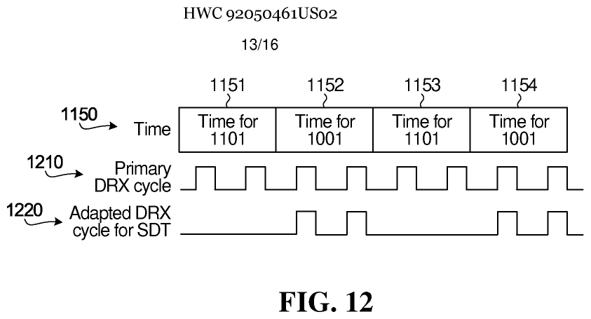

One example of how the apparatus 1002 of FIG. 10 may adapt discontinuous reception (DRX) and monitor 1067 a PDCCH during DRX is illustrated in FIG. 12. The total time resource 1150 and the time resources 1151 to 1154 shown in FIG. 12 may be those illustrated above with reference to FIG. 11. Given that the RIS 1003 does not serve the network device 1001 during the time periods represented by the time resources 1151 and 1153, if the apparatus 1002 communicates with the network device 1001 via the RIS 1003 and does not use a different beam (e.g., beam 1111 of FIG. 11) to directly communicate with the network device 1001, the apparatus 1002 may not need to monitor a downlink control channel during the time periods represented by the time resources 1151 and 1153, for example to receive 1069 dynamic grants or feedback from the network device 1001. Therefore, the apparatus 1002 may adapt the primary DRX cycle 1210 not to monitor the PDCCH during the time periods represented by the time resources 1151 and 1153. The apparatus 1002 may monitor 1067 the PDCCH during the adapted DRX cycle 1220 to receive 1069 at least one of dynamic grants or feedback from the network device 1001. The adapted DRX cycle 1220 may correspond to time periods represented by the time resources 1152 and 1154, as illustrated in FIG. 12. Moreover, during time resources 1152 and 1154, the apparatus 1002 may remain “on” for a longer duration (e.g. to receive dynamic grants or feedback from the network device 1001).

In some embodiments, if the apparatus uses a different beam (e.g., beam 1111 of FIG. 11) to directly communicate with the network device 1001 while the RIS 1003 does not serve the network device 1001, the apparatus 1002 may not need to adapt the primary DRX cycle 1210.

Referring back to FIG. 10, after the one or more subsequent transmission (e.g., subsequent SDTs) are finished, at step 1070, the network device 1001 may send an RRC release message with suspended indication to the apparatus 1002.

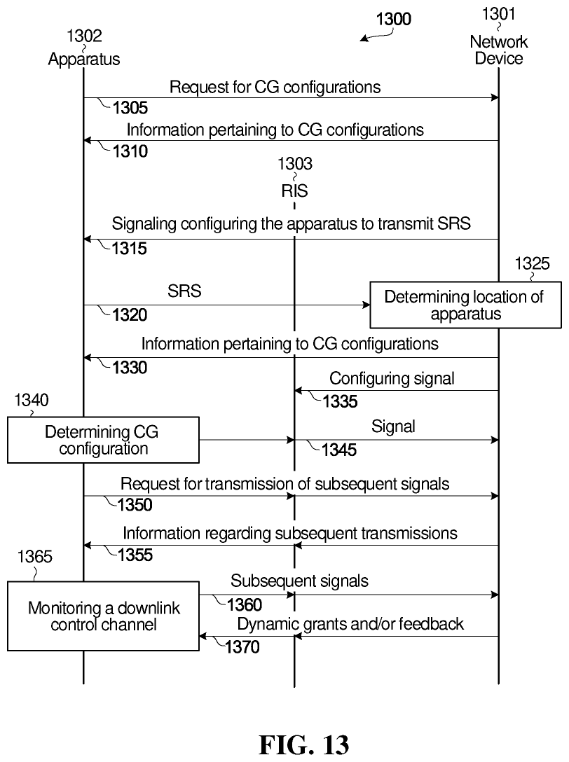

FIG. 13 is a signal flow diagram illustrating an example method 1300 for communication between an apparatus 1302 and a network device 1301, involving an RIS 1303, in accordance with examples of the present disclosure.

The example method 1300 is comprised of steps 1305, 1310, 1315, 1320, 1325, 1330, 1335, 1340, 1345, 1350, 1355, 1360, 1365, and 1370. Some of these steps may be optional. It should be understood that, in some implementations, the order of one or more steps 1305, 1310, 1315, 1320, 1325, 1330, 1335, 1340, 1345, 1350, 1355, 1360, 1365, and 1370 may be changed.

In some embodiments, the network device 1301 and the apparatus 1302 and the RIS 1303 shown in FIG. 13 may be employed in a network that is similar to the network 500 illustrated in FIG. 5 or the network 600 illustrated in FIG. 6. In some embodiments, the network device 1301 may be a BS and the apparatus 1302 may be a UE.

At step 1305, an apparatus 1302 may transmit, to a network device 1301, a request for one or more configured grant (CG) configurations to be used by the apparatus 1302 for transmission of a signal during an inactive state. In some embodiments, the inactive state may refer to RRC_INACTIVE state.

At step 1310, the network device 1301 may transmit, to the apparatus 1302, information pertaining to CG configurations indicating one or more resources that are available to be used by the apparatus 1302 for the communication with the network device 1301. In some embodiments, the information pertaining to CG configurations may be included in a radio resource control (RRC) message that triggers the apparatus 1302 to transition from an RRC_CONNECTED state to an RRC_INACTIVE state.

According to some embodiments, the information pertaining to CG configurations may include at least one of: one or more CG configurations for the communication with the network device, one or more CG configurations associated with the one or more events, or information indicative of how to detect an RIS (e.g., RIS 1303). The one or more CG configurations associated with the one or more events may include at least one of: information indicative of a frequency band associated with the RIS 1303; or information indicative of one or more areas in which the apparatus is served by the RIS 1303. The information indicative of how to detect the RIS may specify detecting the RIS based on at least one of: one or more RIS broadcast signals transmitted from the RIS 1303, information indicative of an area covered by the RIS 1303, or an indication of the RIS 1303 included in a paging signal and/or SSB signal transmitted from the network device 1301. The indication of the RIS 1303 may be overlaid onto the paging signal and/or SSB signal via a media based modulation (MBM).

According to some embodiments, the information pertaining to CG configurations may include at least one of: one or more CG configurations for the communication with the network device 1301, or one or more indications for one or more CG configurations that are available for use by the apparatus 1302 to transmit the signal.

At step 1315, the network device 1301 may transmit, to the apparatus 1302, a signaling configuring the apparatus 1302 to transmit a sounding reference signal (SRS).

At step 1320, the apparatus 1302 may transmit, to the network device 1301, the SRS to enable the network device 1301 to determine the location of the apparatus 1302.

At step 1325, the network device 1301 may determine the location of the apparatus 1302 based on the SRS received from the apparatus 1302.

At step 1330, the network device 1301 may transmit, to the apparatus 1302, information pertaining to CG configurations. The information pertaining to CG configurations transmitted at step 1330 may be different from the information pertaining to CG configurations transmitted at step 1310. The information pertaining to CG configurations transmitted at step 1330 may include information indicative of one or more particular CG resource sets for use by the apparatus 1302 to transmit the signal.

In some embodiments, the step 1330 may be performed after step 1325. For example, in some embodiments where the information pertaining to CG configurations includes the information indicative of the one or more particular CG resource sets for use by the apparatus 1302 to transmit the signal, the network device 1301 may transmit, to the apparatus 1302, the information pertaining to CG configurations after the location of the apparatus 1302 is determined to be within an area covered by the RIS 1303.

At step 1335, the RIS 1303 may be configured by the network device 1301 to redirect the signal transmitted by the apparatus to the network device based on the CG configuration determined to be used by the apparatus 1302 or the CG configuration that aligns with the particular CG resources or CG resource sets to be used by the apparatus 1302 for the transmission of the signal during the inactive state. For example, the network device 1301 may transmit a signal configuring the RIS 1303 to redirect the signal transmitted by the apparatus 1302 to the network device 1301 based on the CG configuration determined to be used by the apparatus 1302 or the CG configuration that aligns with the particular CG resources or CG resource sets to be used by the apparatus 1302 for the transmission of the signal during the inactive state.

At step 1340, the apparatus 1302 may determine, based on the information pertaining to CG configurations, a CG configuration to be used by the apparatus 1302 for transmission of the signal during the inactive state. The determined CG configuration may be associated with one or more events within an area in which the apparatus 1302 and the network device 1301 are located. In some embodiments, the one or more events may be associated with at least one of the RIS 1303 within the area or a location of the apparatus 1302 within the area. In some embodiments, the determined CG configuration may comprise a time and frequency resource associated with the one or more events. In some embodiments, the area may refer to at least one of: a cell area in which the apparatus 1302 receives the RRC message that triggers the apparatus 1302 to transition from the RRC_CONNECTED state to the RRC_INACTIVE state; or a radio access network (RAN) based notification area (RNA).

According to some embodiments, determining the CG configuration may include at least one of: detecting the RIS 1303 using the information indicative of how to detect the RIS 1303 included in the information pertaining to CG configurations, determining proximity between the RIS 1303 and the apparatus 1302, or selecting a time frequency resource associated with the RIS 1303 based on the proximity between the RIS 1303 and the apparatus 1302. The selected time frequency resource may be indicated as the CG resource in the CG configuration.

According to some embodiments, determining the CG configuration may include selecting a time frequency resource associated with the RIS 1303 and available for the transmission of the signal based on at least one of the one or more CG configurations for the communication with the network device 1301, or the one or more indications for one or more CG configurations that are available for use by the apparatus 1302 to transmit the signal. Alternatively, determining the CG configuration may include selecting a time frequency resource associated with the RIS 1303 based on the information indicative of the one or more particular CG resource sets for use by the apparatus 1302 to transmit the signal. In either case, the selected time frequency resource may be indicated as the CG resource in the CG configuration.

At step 1345, the apparatus 1302 may transmit the signal over a CG resource indicated in the determined CG configuration during the inactive state (e.g., RRC_INACTIVE). In some embodiments, the signal may comprise a connection resume request message and payload data. In some embodiments, the signal conveys data having a size that is equal to or less than a particular data size. In some embodiments, the signal transmitted by the apparatus 1302 may be redirected to the network device 1301 via the RIS 1303.

At step 1350, the apparatus 1302 may transmit, to the network device 1301, a request for transmission of one or more subsequent signals including at least one of a buffer status report or information that facilitates the transmission of the one or more subsequent signals.

At step 1355, the network device 1301 may transmit, to the apparatus 1302, information regarding the subsequent transmissions. The information regarding the subsequent transmissions may include information indicative of at least one of: a maximum number of the one or more subsequent transmissions, or a direction in which the apparatus 1302 is to transmit the one or more subsequent signals during a time period that the RIS 1303 is not configured to redirect the one or more subsequent signals to the network device 1301.

At step 1360, the apparatus 1302 may transmit, to the network device 1301, one or more subsequent signals. In some embodiments, step 1360 may be performed after the apparatus 1301 receives the information regarding the subsequent transmissions at step 1355. In some embodiments, transmitting the one or more subsequent signals may include determining a time frequency resource based on the determined CG configuration, and transmitting a subsequent signal over the determined time frequency resource during the inactive state.

At step 1365, during the transmission of the one or more subsequent signals, the apparatus 1302 may monitor a downlink control channel. In some embodiments, the apparatus 1302 may monitor the downlink control channel during discontinuous reception (DRX). In some embodiments, the apparatus 1302 may monitor the downlink control channel during a time period that the RIS 1303 is configured to redirect the one or more subsequent signals to the network device 1301.

In some embodiments, the apparatus 1302 may monitor 1365 a downlink control channel to receive 1370 at least one of dynamic grants or feedback from the network device 1301. In other words, the apparatus 1302 may receive 1370 at least one of dynamic grants (may refer to other resources the apparatus may use for transmitting one or more subsequent signals) or feedback from the network device 1301.

In some embodiments, the downlink control channel may be a physical downlink control channel (PDCCH).

In some embodiments, it is to be understood that if resources that are allocated or allowed for the SDT (e.g., CG-SDT) are unavailable or invalid, the apparatus may perform RA-SDT. If no SDT configuration is available, the apparatus (e.g. UE) may perform a non-SDT data transmission (e.g. the apparatus may transition to RRC_connected state and then transmit the data). Otherwise, the apparatus may select an SSB with RSRP measurement that is above a certain threshold, for SDT. For uplink (UL) carrier selection, both normal UL (NUL) carrier and supplementary UL (SUL) carrier may be indicated in the system information message(s), and the apparatus may select a NUL or a SUL carrier based on the RSRP measurement. For example, the apparatus may select NUL if the RSRP is greater than or equal to a certain threshold, and select SUL if the RSRP is less that the certain threshold. Note that resources for RA-SDT and CG-SDT may be configured on either or both of NUL and SUL carriers. The use of SUL carriers may help improve UL coverage by transmitting at a low frequency when the RSRP strength is below a certain threshold.

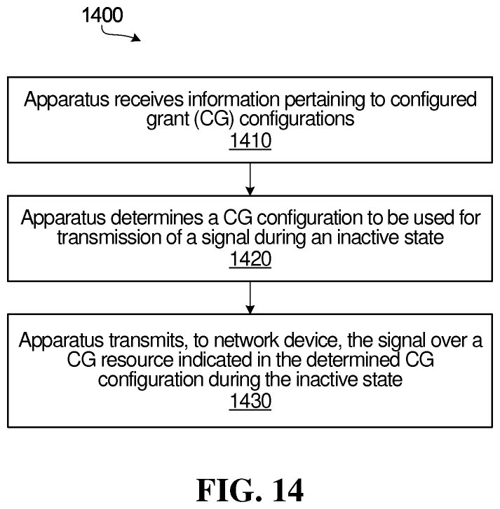

FIG. 14 illustrates an example method for communication between an apparatus and a network device during an inactive state, in accordance with embodiments of the present disclosure. The example method 1400 is comprised of steps 1410, 1420, and 1430.

In some embodiments, the network device and the apparatus of FIG. 14 may be employed in a network that is similar to the network 500 illustrated in FIG. 5 or the network 600 illustrated in FIG. 6. In some embodiments, the network device may be a BS and the apparatus may be a UE.

At step 1410, the apparatus may receive information pertaining to configured grant (CG) configurations indicating one or more resources that are available to be used by the apparatus for the communication with the network device. The network device may transmit the information pertaining to CG configurations. In some embodiments, step 1410 may be similar to step 1310 in FIG. 13.

At step 1420, the apparatus may determine, based on the information pertaining to CG configurations, a CG configuration to be used by the apparatus for transmission of a signal during an inactive state. The determined CG configuration may be associated with one or more events within an area in which the apparatus and the network device are located. In some embodiments, step 1420 may be similar to step 1340 in FIG. 13.

At step 1430, the apparatus may transmit the signal over a CG resource indicated in the determined CG configuration during the inactive state. The network device may receive the signal transmitted from the apparatus over the CG resource associated with the determined CG configuration during the inactive state. In some embodiments, step 1430 may be similar to step 1345 in FIG. 13.

Examples of apparatuses and network devices (e.g., UE or other terminal side apparatus and BS or other network side device) to perform the various methods described herein are also disclosed.

For example, a network device may include a memory to store processor-executable instructions, and a processor to execute the processor-executable instructions. When the processor executes the processor-executable instructions, the processor may be caused to perform the method steps of one or more of the network devices as described herein, e.g., in relation to FIG. 13. For example, the processor may cause the network device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method for use by an apparatus for communication with a network device, comprising:
receiving information pertaining to configured grant (CG) configurations indicating one or more resources that are available to be used by the apparatus for the communication with the network device;
determining, based on the information pertaining to CG configurations, a CG configuration to be used by the apparatus for transmission of a signal during an inactive state, the determined CG configuration associated with one or more events within an area in which the apparatus and the network device are located; and
transmitting the signal over a CG resource indicated in the determined CG configuration during the inactive state.

2. The method of claim 1, wherein the one or more events are associated with at least one of a reconfigurable intelligent surface (RIS) within the area or a location of the apparatus within the area.

3. The method of claim 2, wherein the determined CG configuration comprises a time and frequency resource associated with the one or more events.

4. The method of claim 2, wherein the information pertaining to CG configurations is included in a radio resource control (RRC) message that triggers the apparatus to transition from an RRC_CONNECTED state to an RRC_INACTIVE state.

5. The method of claim 4, wherein the area refers to at least one of:
a cell area in which the apparatus receives the RRC message that triggers the apparatus to transition from the RRC_CONNECTED state to the RRC_INACTIVE state; or
a radio access network (RAN) based notification area (RNA).

6. A method applied in a device for communication with an apparatus, comprising:
transmitting information pertaining to configured grant (CG) configurations indicating one or more resources that are available to be used by the apparatus for communication with the device, wherein the information pertaining to CG configurations is used for determining a CG configuration that is associated with one or more events within an area in which the apparatus and the device are located; and
receiving the signal transmitted from the apparatus over a CG resource associated with the CG configuration determined using the information pertaining to CG configurations during the inactive state.

7. The method of claim 6, wherein the one or more events are associated with at least one of a reconfigurable intelligent surface (RIS) within the area or a location of the apparatus within the area.

8. The method of claim 7, wherein the determined CG configuration comprises a time and frequency resource associated with the one or more events.

9. The method of claim 7, wherein the information pertaining to CG configurations is transmitted in a radio resource control (RRC) message that triggers the apparatus to transition from an RRC_CONNECTED state to an RRC_INACTIVE state.

10. The method of claim 9, wherein the area refers to at least one of:
a cell area in which the apparatus receives the RRC message that triggers the apparatus to transition from the RRC_CONNECTED state to the RRC_INACTIVE state; or
a radio access network (RAN) based notification area (RNA).

11. An apparatus, comprising:
at least one processor coupled with at least one memory storing one or more instructions that are capable of being run on the at least one processor, and when the one or more instructions are run, the apparatus is enabled for:
receiving information pertaining to configured grant (CG) configurations indicating one or more resources that are available to be used by the apparatus for the communication with the network device; determining, based on the information pertaining to CG configurations, a CG configuration to be used by the apparatus for transmission of a signal during an inactive state, the determined CG configuration associated with one or more events within an area in which the apparatus and the network device are located; and
transmitting the signal over a CG resource indicated in the determined CG configuration during the inactive state.

12. The apparatus of claim 11, wherein the one or more events are associated with at least one of a reconfigurable intelligent surface (RIS) within the area or a location of the apparatus within the area.

13. The apparatus of claim 12, wherein the determined CG configuration comprises a time and frequency resource associated with the one or more events.

14. The apparatus of claim 13, wherein the information pertaining to CG configurations is included in a radio resource control (RRC) message that triggers the apparatus to transition from an RRC_CONNECTED state to an RRC_INACTIVE state.

15. The apparatus of claim 14, wherein the area refers to at least one of: a cell area in which the apparatus receives the RRC message that triggers the apparatus to transition from the RRC_CONNECTED state to the RRC_INACTIVE state; or a radio access network (RAN) based notification area (RNA).

16. An apparatus, comprising:
at least one processor coupled with at least one memory storing one or more instructions that are capable of being run on the at least one processor, and when the one or more instructions are run, the apparatus is enabled for:
transmitting information pertaining to configured grant (CG) configurations indicating one or more resources that are available to be used by the apparatus for communication with the device, wherein the information pertaining to CG configurations is used for determining a CG configuration that is associated with one or more events within an area in which the apparatus and the device are located; and
receiving the signal transmitted from the apparatus over a CG resource associated with the CG configuration determined using the information pertaining to CG configurations during the inactive state.

17. The apparatus of claim 16, wherein the one or more events are associated with at least one of a reconfigurable intelligent surface (RIS) within the area or a location of the apparatus within the area.

18. The apparatus of claim 17, wherein the determined CG configuration comprises a time and frequency resource associated with the one or more events.

19. The apparatus of claim 18, wherein the information pertaining to CG configurations is transmitted in a radio resource control (RRC) message that triggers the apparatus to transition from an RRC_CONNECTED state to an RRC_INACTIVE state.

20. The apparatus of claim 19, wherein the area refers to at least one of: a cell area in which the apparatus receives the RRC message that triggers the apparatus to transition from the RRC_CONNECTED state to the RRC_INACTIVE state; or a radio access network (RAN) based notification area (RNA).
